(19) United States
(12) Patent Application Publication
(10) Pub. No.: US 2025/0378506 A1
(43) Pub. Date: Dec. 11, 2025

(54) SYSTEMS AND METHODS FOR GENERATING AND EXECUTING AUDITS AND PROVIDING AUDIT RESULTS

(71) Applicant: Cable Audit Associates, LLC, Greenwood Village, CO (US)

(72) Inventor: Jason Blais, Greenwood Village, CO (US)

(73) Assignee: Cable Audit Associates, LLC, Greenwood Village, CO (US)

(21) Appl. No.: 18/806,625

(22) Filed: Aug. 15, 2024

Related U.S. Application Data
(60) Provisional application No. 63/658,361, filed on Jun. 10, 2024.

(51) Int. Cl. G06Q 40/12

(52) U.S. Cl. CPC G06Q 40/125

(57) ABSTRACT

An example method includes receiving requests to create an audit and a process for the audit. Input, modification and output blocks are provided for display and selection. Blocks are selected and configuration information is provided for the block. The selected blocks are added to the process. A request to execute the process is received. Input audit data specified by configuration information for an input block is received, and modifications specified by configuration information for modification blocks are applied to the input audit data to produce output audit data. The output audit data is stored according to configuration information for an output block. The output audit data may be provided for display.

### CROSS-REFERENCE TO RELATED APPLICATIONS

This application claims priority to and seeks the benefit of U.S. Provisional Patent Application No. 63/658,361, filed on Jun. 10, 2024, and entitled “SYSTEMS AND METHODS FOR GENERATING AND VIEWING AUDITS,” which is incorporated in its entirety herein by reference.

### FIELD OF THE INVENTION(S)

Embodiments of the present invention(s) are generally related to audit systems, and in particular to systems for auditing revenue from content.

### BACKGROUND

Technology has provided consumers with many options to consume content. For example, consumers may consume content not only by traditional broadcast means but also by different subscription channels (each with their own markets), pay per view channels, advertising-supported applications (for example, on a smart device), consumer renting, consumer purchasing, and/or limited time exclusivity to name only a few. As a consequence, the number, complexity, and models of agreements for different distribution partners for a single content owner has dramatically increased.

Content owners may have contractual agreements with distribution partners that have audit clauses that give content owners the right to audit revenue of distribution partners from content owned by content owners. Content owners may insist upon such audit clauses so as to verify that content owners are being paid the appropriate amount of royalties from the content. For example, a content owner, such as a movie studio, may have an agreement with a distribution partner, such as a digital streaming service, that requires the distribution partner to pay the content owner a fixed royalty or license fee for every instance of streaming to a consumer of a particular piece of content, such as a movie. The agreement may also have an audit clause that allows the content owner to audit revenue of the distribution partner from the streaming of the content. Moreover, a content owner may have numerous agreements with numerous different distribution partners, such as hundreds of distribution partners.

The content owner may employ auditors or use external auditors to audit revenue of a distribution partner. When the auditors are auditing the revenue, the auditors may collect relevant documents such as agreements between the content owner and the distribution partner, distribution partner revenue, invoices, tax filings, consumer subscription data, emails and other communications, and other books and records. The auditors may then use the relevant documents to perform the audit. Performing the audit may involve auditors manually organizing and analyzing the relevant documents to collect revenue data, manually creating spreadsheets to analyze the revenue data, and manually generating reports summarizing the results of the analysis.

Such an approach has significant drawbacks, amongst them being the difficulty and complexity in determining audit results in an expedient fashion. Similarly, this approach may not scale to the numerous distribution partners that the content owner may have. As a result, the content owner may not obtain the appropriate amounts of revenue from their content.

### SUMMARY

In some aspects, the techniques described herein relate to a non-transitory computer-readable medium including executable instructions, the executable instructions being executable by one or more processors to perform a method, the method including: receiving a request to create an audit, the request specifying a party to be audited; receiving one or more requests to create one or more processes for the audit; for each process of the one or more processes: providing for display multiple blocks for selection, the multiple blocks including an input block, multiple modification blocks, and an output block; receiving a selection of an input block and an input configuration for the input block, the input configuration specifying initial input audit data associated with the party; adding the input block to the process; receiving one or more selections of one or more modification blocks and one or more modification configurations for the one or more modification blocks, the one or more modification configurations specifying one or more modifications to be made to data received by the one or more modification blocks; adding the one or more modification blocks to the process; receiving a selection of an output block and an output configuration for the output block; and adding the output block to the process; receiving a request to execute a particular process of the one or more processes, the particular process including a particular input block, one or more particular modification blocks, and a particular output block; receiving particular initial input audit data specified by a particular input configuration of the particular input block; applying one or more particular modifications specified by one or more particular modification configurations of the one or more particular modification blocks to the particular initial input audit data to produce particular final output audit data; storing the particular final output audit data according to a particular output configuration of the particular output block; and providing the particular final output audit data for display.

In some aspects, the techniques described herein relate to a non-transitory computer-readable medium wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

In some aspects, the techniques described herein relate to a non-transitory computer-readable medium wherein the method further includes, for the particular process of the one or more processes: receiving a request to view intermediate output data produced by a particular modification specified by a particular modification configuration of a particular modification block of the one or more particular modification blocks; applying the particular modification to intermediate input audit data received by the particular modification block to produce intermediate output audit data; and providing the intermediate output audit data for display.

In some aspects, the techniques described herein relate to a non-transitory computer-readable medium wherein the method further includes, for each process of the one or more processes: receiving a selection of a connector to be placed between a first block and a second block; receiving a selection of the first block and the second block, and connecting the first block and the second block with the connector, such that intermediate output audit data of the first block is to become intermediate input audit data of the second block.

In some aspects, the techniques described herein relate to a non-transitory computer-readable medium wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and the method further includes: receiving a request to perform the audit; for each second particular process other than the first particular process of the one or more processes, a second particular process including a second particular input block, one or more second particular modification blocks, and a second particular output block: receiving second particular initial input audit data specified by a second particular input configuration of the second particular input block; applying one or more second particular modifications specified by one or more second particular modification configurations of the one or more second particular modification blocks to the second particular initial input audit data to produce second particular final output audit data; and storing the second particular final output audit data according to a second particular output configuration of the second particular output block; determining, based on one or more second particular final output audit data, a result of the audit; and providing the result of the audit for display.

In some aspects, the techniques described herein relate to a non-transitory computer-readable medium wherein the audit is of revenue, and the method further includes: receiving an amount of the revenue; determining, based on the one or more second particular final output audit data, an audited amount of the revenue; and determining, based on the amount of the revenue and the audited amount of the revenue, the result of the audit.

In some aspects, the techniques described herein relate to a non-transitory computer-readable medium wherein the audit is a first audit, the particular input configuration is a first particular input configuration, the particular initial input audit data is first particular initial input audit data, the particular output configuration is a first particular output configuration, and the method further includes: receiving a request to create a second audit, the request specifying the party; receiving a request to associate the particular process with the second audit; receiving a second particular input configuration specifying second particular initial input audit data for the particular input block; receiving a second particular output configuration for the particular output block; receiving a request to execute the particular process for the second audit; receiving the second particular initial input audit data specified by the second particular input configuration; applying the one or more modifications specified by the one or more particular modification configurations of the one or more particular modification blocks to the second particular initial input audit data to produce second particular final output audit data; storing the second particular final output audit data according to the second particular output configuration; and providing the second particular final output audit data for display.

In some aspects, the techniques described herein relate to a method including: receiving a request to create an audit, the request specifying a party to be audited; receiving one or more requests to create one or more processes for the audit; for each process of the one or more processes: providing for display multiple blocks for selection, the multiple blocks including an input block, multiple modification blocks, and an output block; receiving a selection of an input block and an input configuration for the input block, the input configuration specifying initial input audit data associated with the party; adding the input block to the process; receiving one or more selections of one or more modification blocks and one or more modification configurations for the one or more modification blocks, the one or more modification configurations specifying one or more modifications to be made to data received by the one or more modification blocks; adding the one or more modification blocks to the process; receiving a selection of an output block and an output configuration for the output block; and adding the output block to the process; receiving a request to execute a particular process of the one or more processes, the particular process including a particular input block, one or more particular modification blocks, and a particular output block; receiving particular initial input audit data specified by a particular input configuration of the particular input block; applying one or more particular modifications specified by one or more particular modification configurations of the one or more particular modification blocks to the particular initial input audit data to produce particular final output audit data; storing the particular final output audit data according to a particular output configuration of the particular output block; and providing the particular final output audit data for display.

In some aspects, the techniques described herein relate to a method, wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

In some aspects, the techniques described herein relate to a method, further including, for the particular process of the one or more processes: receiving a request to view intermediate output data produced by a particular modification specified by a particular modification configuration of a particular modification block of the one or more particular modification blocks; applying the particular modification to intermediate input audit data received by the particular modification block to produce intermediate output audit data; and providing the intermediate output audit data for display.

In some aspects, the techniques described herein relate to a method, further including, for each process of the one or more processes: receiving a selection of a connector to be placed between a first block and a second block; receiving a selection of the first block and the second block, and connecting the first block and the second block with the connector, such that intermediate output audit data of the first block is to become intermediate input audit data of the second block.

In some aspects, the techniques described herein relate to a method wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and further including: receiving a request to perform the audit; for each second particular process other than the first particular process of the one or more processes, a second particular process including a second particular input block, one or more second particular modification blocks, and a second particular output block: receiving second particular initial input audit data specified by a second particular input configuration of the second particular input block; applying one or more second particular modifications specified by one or more second particular modification configurations of the one or more second particular modification blocks to the second particular initial input audit data to produce second particular final output audit data; and storing the second particular final output audit data according to a second particular output configuration of the second particular output block; determining, based on one or more second particular final output audit data, a result of the audit; and providing the result of the audit for display.

In some aspects, the techniques described herein relate to a method wherein the audit is of revenue, and further including: receiving an amount of the revenue; determining, based on the one or more second particular final output audit data, an audited amount of the revenue; and determining, based on the amount of the revenue and the audited amount of the revenue, the result of the audit.

In some aspects, the techniques described herein relate to a method wherein the audit is a first audit, the particular input configuration is a first particular input configuration, the particular initial input audit data is first particular initial input audit data, the particular output configuration is a first particular output configuration, and further including: receiving a request to create a second audit, the request specifying the party; receiving a request to associate the particular process with the second audit; receiving a second particular input configuration specifying second particular initial input audit data for the particular input block; receiving a second particular output configuration for the particular output block; receiving a request to execute the particular process for the second audit; receiving the second particular initial input audit data specified by the second particular input configuration; applying the one or more modifications specified by the one or more particular modification configurations of the one or more particular modification blocks to the second particular initial input audit data to produce second particular final output audit data; storing the second particular final output audit data according to the second particular output configuration; and providing the second particular final output audit data for display.

In some aspects, the techniques described herein relate to a system including at least one processor and memory containing executable instructions, the executable instructions being executable by the at least one processor to: receive a request to create an audit, the request specifying a party to be audited; receive one or more requests to create one or more processes for the audit; for each process of the one or more processes: provide for display multiple blocks for selection, the multiple blocks including an input block, multiple modification blocks, and an output block; receive a selection of an input block and an input configuration for the input block, the input configuration specifying initial input audit data associated with the party; add the input block to the process; receive one or more selections of one or more modification blocks and one or more modification configurations for the one or more modification blocks, the one or more modification configurations specifying one or more modifications to be made to data received by the one or more modification blocks; add the one or more modification blocks to the process;

receive a selection of an output block and an output configuration for the output block; and add the output block to the process; receive a request to execute a particular process of the one or more processes, the particular process including a particular input block, one or more particular modification blocks, and a particular output block; receive particular initial input audit data specified by a particular input configuration of the particular input block; apply one or more particular modifications specified by one or more particular modification configurations of the one or more particular modification blocks to the particular initial input audit data to produce particular final output audit data; store the particular final output audit data according to a particular output configuration of the particular output block; and provide the particular final output audit data for display.

In some aspects, the techniques described herein relate to a system wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

In some aspects, the techniques described herein relate to a system wherein the executable instructions are further executable by the at least one processor to, for the particular process of the one or more processes: receive a request to view intermediate output data produced by a particular modification specified by a particular modification configuration of a particular modification block of the one or more particular modification blocks; apply the particular modification to intermediate input audit data received by the particular modification block to produce intermediate output audit data; and provide the intermediate output audit data for display.

In some aspects, the techniques described herein relate to a system wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and the executable instructions are further executable by the at least one processor to: receive a request to perform the audit; for each second particular process other than the first particular process of the one or more processes, a second particular process including a second particular input block, one or more second particular modification blocks, and a second particular output block: receive second particular initial input audit data specified by a second particular input configuration of the second particular input block; apply one or more second particular modifications specified by one or more second particular modification configurations of the one or more second particular modification blocks to the second particular initial input audit data to produce second particular final output audit data; and store the second particular final output audit data according to a second particular output configuration of the second particular output block; determine, based on one or more second particular final output audit data, a result of the audit; and provide the result of the audit for display.

In some aspects, the techniques described herein relate to a system wherein the audit is of revenue, and the executable instructions are further executable by the at least one processor to: receive an amount of the revenue; determine, based on the one or more second particular final output audit data, an audited amount of the revenue; and determine, based on the amount of the revenue and the audited amount of the revenue, the result of the audit.

In some aspects, the techniques described herein relate to a system wherein the audit is a first audit, the particular input configuration is a first particular input configuration, the particular initial input audit data is first particular initial input audit data, the particular output configuration is a first particular output configuration, and the executable instructions are further executable by the at least one processor to: receive a request to create a second audit, the request specifying the party; receive a request to associate the particular process with the second audit; receive a second particular input configuration specifying second particular initial input audit data for the particular input block; receive a second particular output configuration for the particular output block; receive a request to execute the particular process for the second audit; receive the second particular initial input audit data specified by the second particular input configuration; apply the one or more modifications specified by the one or more particular modification configurations of the one or more particular modification blocks to the second particular initial input audit data to produce second particular final output audit data; store the second particular final output audit data according to the second particular output configuration; and provide the second particular final output audit data for display.

### BRIEF DESCRIPTION OF THE DRAWINGS

FIG. 1 is a block diagram depicting an example environment in which an audit system may operate in some embodiments.

FIG. 2 is a block diagram depicting components of an audit system in some embodiments.

FIG. 3 is a diagram depicting systems and processes for generating audits in some embodiments.

FIG. 4A depicts an example architecture for an audit system in some embodiments.

FIG. 4B depicts a portion of another example architecture for an audit system in some embodiments.

FIG. 5 is a flow diagram depicting method for providing output data and/or results of audits in some embodiments.

FIGS. 6A-6G depict example user interfaces provided by an audit system in some embodiments.

FIGS. 7A-7F depict additional example user interfaces provided by an audit system in some embodiments.

FIGS. 8A-8O depict additional example user interfaces provided by an audit system in some embodiments.

FIG. 9 depicts another example user interface provided by an audit system in some embodiments.

FIG. 10 depicts a block diagram of an example digital device in some embodiments.

Throughout the drawings, like reference numerals will be understood to refer to like parts, components, and structures.

### DETAILED DESCRIPTION

Various embodiments of an audit system allow users to create audits of content revenue, to create repeatable processes for audits, and to execute the audit processes and audits. The audit system in some embodiments also provides the results of the audits for display to users, such as content owner representatives. The audit system thereby allows the users to quickly and easily determine if the content owners are being paid the appropriate amount of revenue for their content by the distribution partners that the content owners license to distribute their content.

In some embodiments, a user of an audit system, such as an auditor working on behalf of a content owner, may create an audit of a distribution partner of revenue from content that the content owner licenses the distribution partner to distribute. The user may request that the audit system ingest data relevant to the audit, such as distribution partner revenue, subscriber information, distribution agreements, and royalty payment data. The audit system may normalize such data and store the normalized data for analysis. The audit system may provide user interfaces that allow the user to create processes to be applied by the audit system to the normalized data. Such processes may be repeatable and scalable. For example, the audit system may apply the processes to audits of the same distribution partner as well as to audits of other distribution partners. The audit system may prepare reports based on the results of the audits and provide the reports for display to users, such as representatives or employees of content owners. This allows the users to determine if there is any variance between the amount of revenue paid to the content owner by the distribution partner and the amount of revenue that should be paid to the content owner by the distribution partner.

Various embodiments of the audit system provide technical solutions to technical problems created by existing approaches to performing audits. One technical problem is that the data required to perform an audit may be in different locations and in different formats. The audit system may store relevant audit data and normalize the audit data so that the audit data may be analyzed and processed. Another technical problem stems from auditors using tools such as spreadsheets to analyze and process audit data. Such spreadsheets may contain formulas and/or macros that are difficult to utilize in other spreadsheets. Moreover, an auditor may have to copy intermediate data from one spreadsheet to another spreadsheet for analysis and processing. Such approaches are neither scalable nor efficient. The audit system may provide technical solutions to such technical problems by allowing users to easily define repeatable processes that may be applied to audit data both across time (for example, for a single distribution partner for different periods of time) as well as across distribution partners (for example, for multiple different distribution partners each licensed to distribute the same content). Moreover, the audit system may store the intermediate data so that auditors may view and analyze the intermediate data. This allows auditors to ensure that the proper processes are being performed and to perform troubleshooting of audit processes.

Another technical problem relates to reports of audit findings. Such reports may be in widely varying formats, which may make it difficult for auditors to compare audit findings for a single item of content or across multiple content items or across multiple distribution partners. In some embodiments, the audit system may provide a user interface that provides audit reports for a content owner for the audits that the content owner has had performed. Such a user interface may allow the content owner to see audit reports for multiple distribution partners for multiple periods of time. Other technical solutions to technical problems that the audit system provides will be apparent.

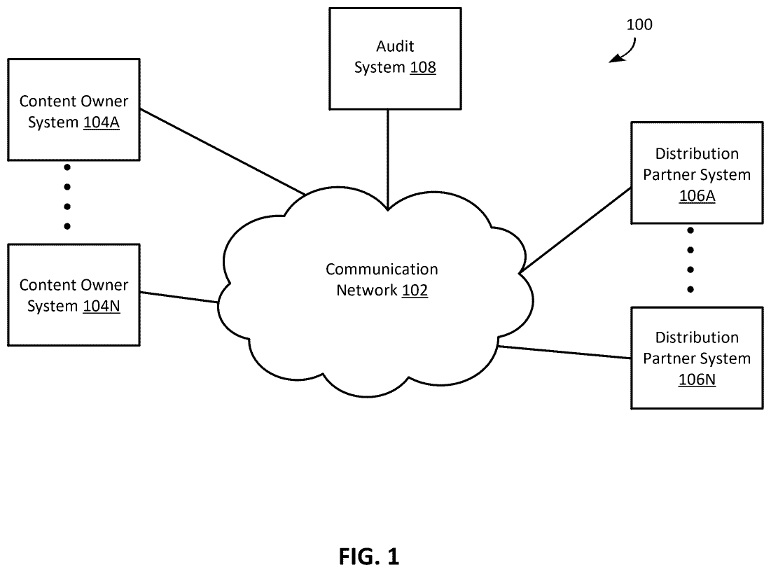

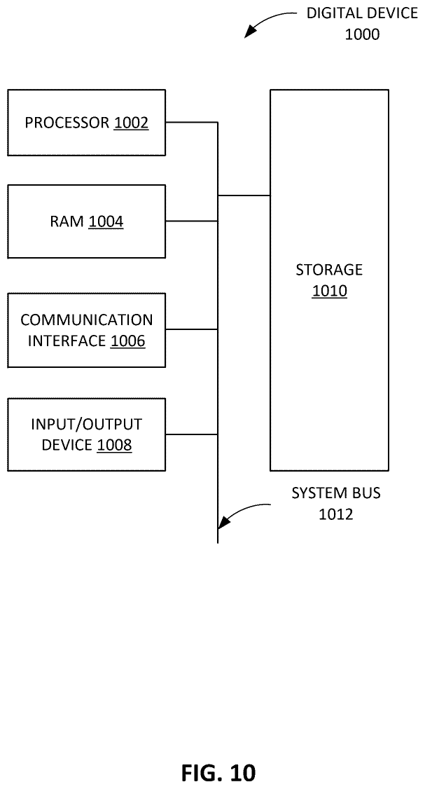

FIG. 1 is a block diagram depicting an example environment 100 in which an audit system 108 may operate in some embodiments. The environment 100 includes the audit system 108, a communication network 102, multiple content owner systems 104A through 104N (referred to as a content owner system 104 or as content owner systems 104), and multiple distribution partner systems 106A through 106N (referred to as a distribution partner system 106 or as distribution partner systems 106). Each of the audit system 108, the content owner system 104, and the distribution partner system 106 may be or include any number of digital devices. A digital device is any device with at least one processor and memory. Digital devices are discussed further herein, for example, with reference to FIG. 10.

Each content owner system 104 may be or include a system for tracking and/or receiving compensation, royalties, and/or the like related to content that is owned or represented by the respective content owner. Content refers to any media that may be consumed. Examples of content include, but are not limited to, video, audio, games, streams, podcasts, programming, movies, series, documentaries, and/or the like. A content owner system 104 may be operated by an entity that owns or represents ownership of the content (for example, an agency that represents select titles of content desired by consumers).

It will be appreciated that each content owner system 104 may be unrelated and independent of any other content owner system 104. As such, the audit system 108 may receive data from any number of distribution partners and provide different audits and audit reports to one or more different content owner systems 104 based on the content represented or owned by the respective content owner.

Content owners (for example, an entity that operates a content owner system 104) may use different distributor partners to distribute the content owned and/or represented by the different content systems. In one example, a distribution partner may be an Over-the-Top (OTT) distribution partner or a traditional distribution partner. An OTT distribution partner may be any service that provides content directly to viewers over the Internet. An OTT distribution partner may bypass cable, broadcast, and satellite television platforms. A traditional distribution partner may provide over-the-air (OTA) services such as television.

Examples of OTT services include, for example, subscription services (SVOD), transactional video on demand (TVOD), electric sell-through (EST), download to rent (DTR), premium video on demand (PVOD), advertising-supported video on demand (AVOD), free ad-supported TV (FAST), and pay TV. In more detail, an SVOD subscription service on demand allows consumers to consume as much content as they desire at a flat rate per month. TVOD services allow consumers pay on a pay-per-view basis. EST services allow a consumer to pay once to gain permanent access to content. DTR service allows a customer access to particular content for a limited time for a smaller fee. PVOD allows a consumer to consume content sooner than they would otherwise (for example, streaming a movie at the same time that movie released in theaters). AVOD and FAST services may allow for free content consumption supported by advertising. FAST often differs from AVOD in that FAST is not “on demand.” Examples of FAST services include Pluto TV (Viacom CBS), Xumo (NBCU), Tubi (Fox), Peacock (NBCU), The Roku Channel (Roku), IMDbTV (Amazon), and Samsung TV+ (Samsung).

Examples of OTT distribution partners may include AMAZON, HULU, NETFLIX, DISNEY+, CURIOSITY STREAM, FUBO, and the like. In another example, a distribution partner may be a traditional distribution partner for distributing content through broadcast television, over cable systems, or the like. It will be appreciated that some distribution partners may distribute content via the Internet as well as over traditional distribution channels. A distribution partner may operate a distribution partner system 106.

The audit system 108 may receive audit data for content, such as distribution partner revenue, subscriber information, distribution agreements, and royalty payment data, from content owner systems 104 and/or from distribution partner systems 106. The audit system 108 may normalize such data and store the normalized data for analysis. The audit system 108 may allow users, such as auditors, to create audits that have associated audit processes using user interfaces provided by the audit system 108. Such processes may be repeatable and scalable. For example, the audit system 108 may apply the processes to subsequent audits of the same distribution partner as well as to audits of other distribution partners. The audit system 108 may prepare reports based on the results of the audits and provide the reports for display to the users. This allows users to determine if there is any variance between the amount of revenue paid to the content owner by the distribution partner and the amount of revenue that should be paid to the content owner by the distribution partner. The audit system 108 may provide additional functionality.

In some embodiments, the communication network 102 may represent one or more computer networks (for example, LAN, WAN, and/or the like). The communication network 102 may provide communication between any of the audit system 108, the content owner system 104, and the distribution partner system 106. In some implementations, the communication network 102 comprises computer devices, routers, cables, and/or other network topologies. In some embodiments, the communication network 102 may be wired and/or wireless. In various embodiments, the communication network 102 may comprise the Internet, one or more networks that may be public, private, IP-based, non-IP based, and so forth.

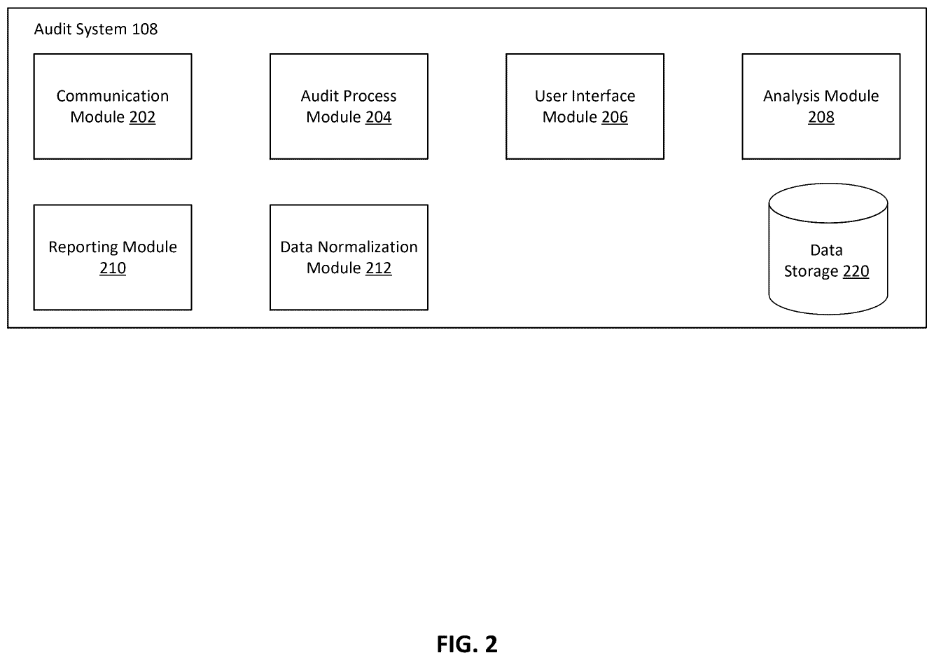

FIG. 2 is a block diagram depicting components of an audit system in some embodiments. The audit system 108 may include a communication module 202, an audit process module 204, a user interface module 206, an analysis module 208, a reporting module 210, a data normalization module 212, and a data storage 220.

The communication module 202 may send requests and/or data between the audit system 108 and any of the content owner systems 104 and the distribution partner systems 106. The communication module 202 may also receive requests and/or data from any of the audit system 108 and any of the content owner systems 104 and the distribution partner systems 106.

The audit process module 204 may execute processes associated with audits. As part of executing processes, the audit process module 204 may receive input audit data, modify the input audit data to produce output audit data, and store the output audit data. The audit process module 204 may also execute an audit, which may involve executing one or more processes associated with the audit.

The user interface module 206 may provide user interfaces that allow users to create audits, view audits, and modify audits. The user interface module 206 may also provide user interfaces that allow users to create processes, view processes, and execute processes. The user interfaces may also allow users to execute processes and audits.

The analysis module 208 may perform analysis on audit data such as Multichannel Video Programming Distributors (MVPD) reports, client agreements, and billing and payments data. The reporting module 210 may generate reports for audits based on the results of one or more processes associated with the audit. The reporting module 210 may provide such reports for display to users. The data normalization module 212 may normalize audit data ingested by the audit system 108. For example, the data normalization module 212 may extract audit data (agreements, revenue data, royalty data, etc.) from various sources, transform audit data into normalized structures and store the normalized data into the data storage 220.

The data storage 220 may include data stored, accessed, and/or modified by any of the modules of the audit system 108. The data storage 220 may include any number of data storage structures such as tables, databases, lists, and/or the like. The data storage 220 may include data that is stored in memory (for example, random access memory (RAM)), on disk, or some combination of in-memory and on-disk.

A module of the audit system 108 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as described herein.

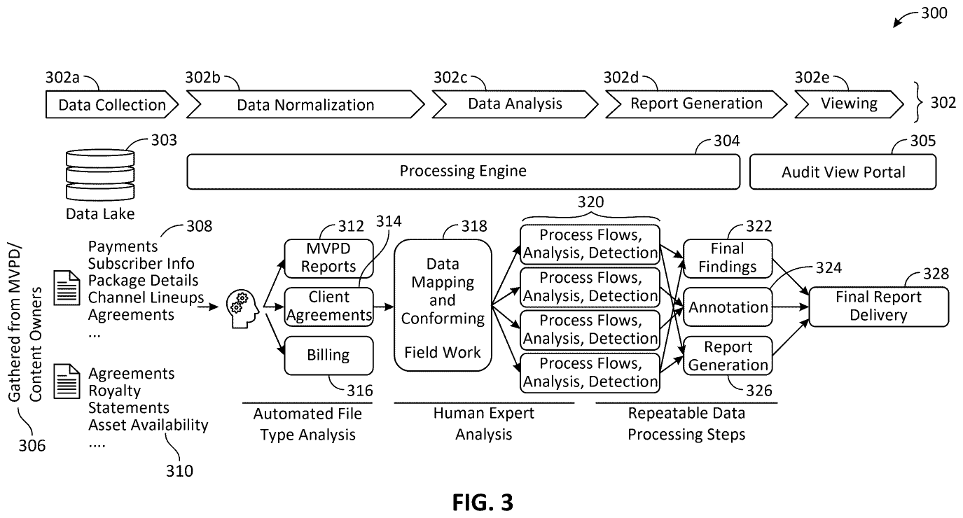

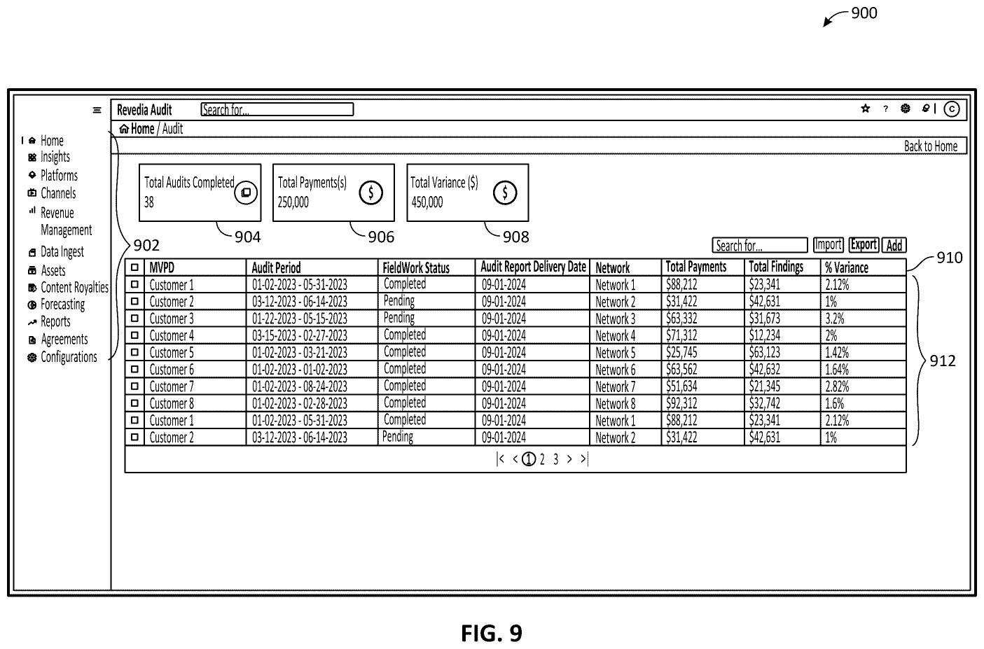

FIG. 3 is a diagram 300 depicting systems and processes for generating audits in some embodiments. A process 302 may have a data collection phase 302a in which audit data is ingested into a data lake 303. The process 302 may also have a data normalization phase 302b, a data analysis phase 302c, and a report generation phase 302d performed by a processing engine 304. The process 302 may also have a viewing phase 302e for viewing audit reports provided via an audit view portal 305. An example user interface that the audit view portal 305 may provide is illustrated in FIG. 9.

The audit system 108 may receive audit data from MVPD or content owners 306 and store the audit data in the data lake 303, which may be stored in the data storage 220. Audit data may include data 308 such as payments, subscriber info, package details, channel lineups, and agreements. Audit data may also include data 310 such as agreements, royalty statements, and asset availability data. In some embodiments, the audit system 108 may automatically ingest data placed in a storage system such as an Amazon Web Services (AWS) bucket.

The audit system 108 (for example, the analysis module 208) may perform an automated file type analysis on MVPD reports 312, client agreements 314, and billing data 316. Users of the audit system 108 may perform data analysis 318 and/or data transformation, such as data mapping and conforming and field work. For example, users may analyze agreements to determine the data required to perform audits, such as revenue data, billing data, and/or subscriber data. The users may also create process flows 320 that apply various processes to audit data and perform analysis and detection. The application of process flows 320 by the audit system 108 may result in the audit system 108 generating final findings 322, annotations 324, and/or reports 326. The audit system 108 (for example, the reporting module 210) may generate a final report 328 and provide the final report 328 for display to users via the audit view portal 305.

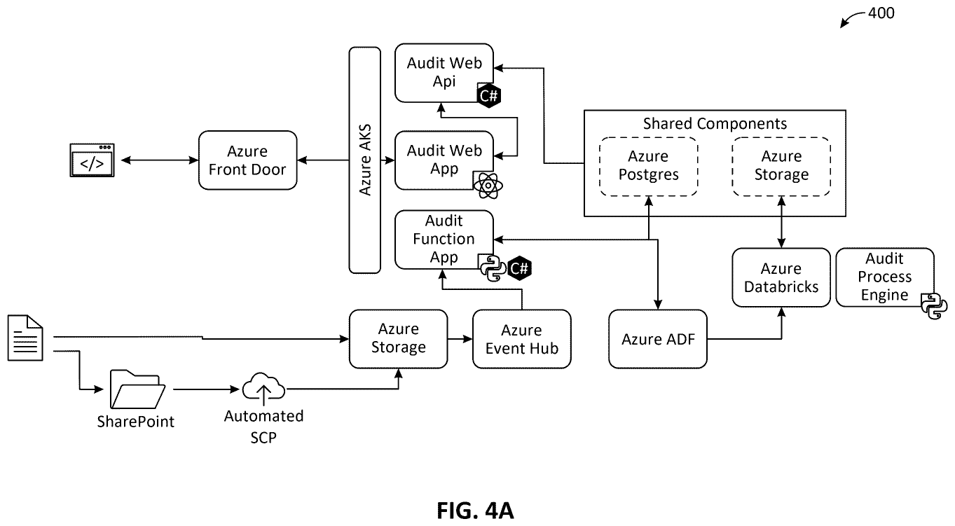

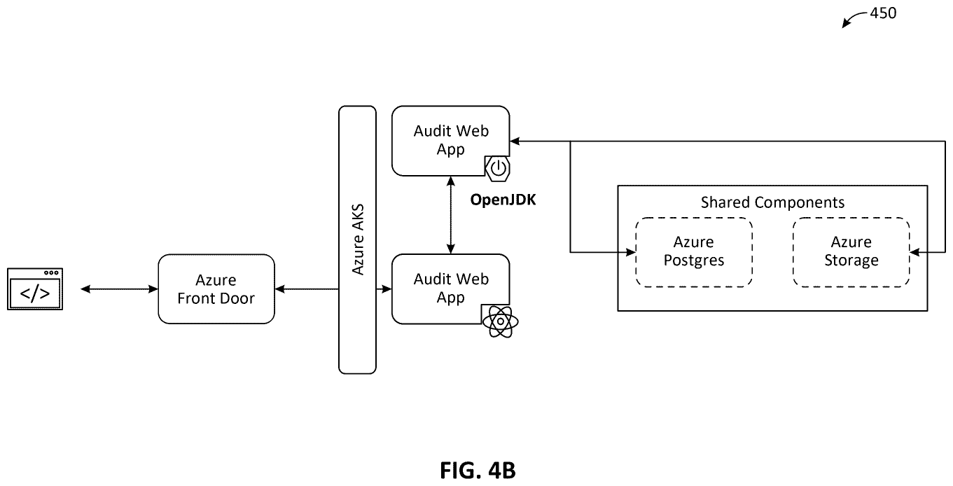

FIG. 4A depicts an example architecture 400 for the audit system 108 in some embodiments. The audit system 108 may utilize products and/or services provided by Microsoft Corporation of Redmond, Washington, such as Azure Storage, Azure AKS, and Azure Databricks. FIG. 4B depicts a portion of another example architecture 450 for the audit system 108 in some embodiments. It will be understood that the audit system 108 may utilize different architectures than those illustrated in FIGS. 4A and 4B and/or that the audit system may utilize more or fewer products and/or services than illustrated and/or products and/or services provided by entities other than Microsoft Corporation.

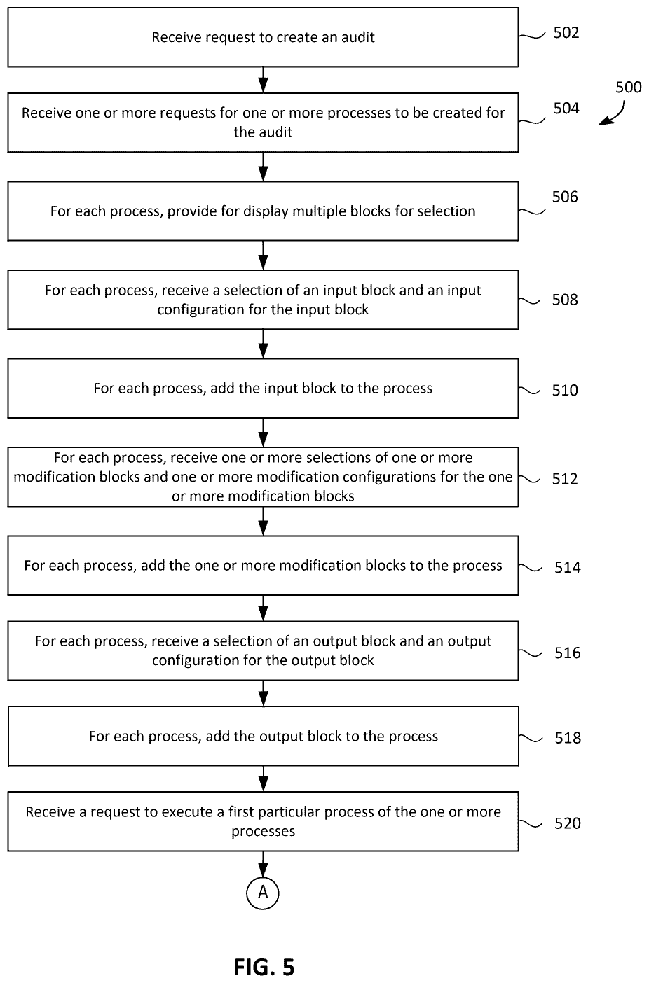

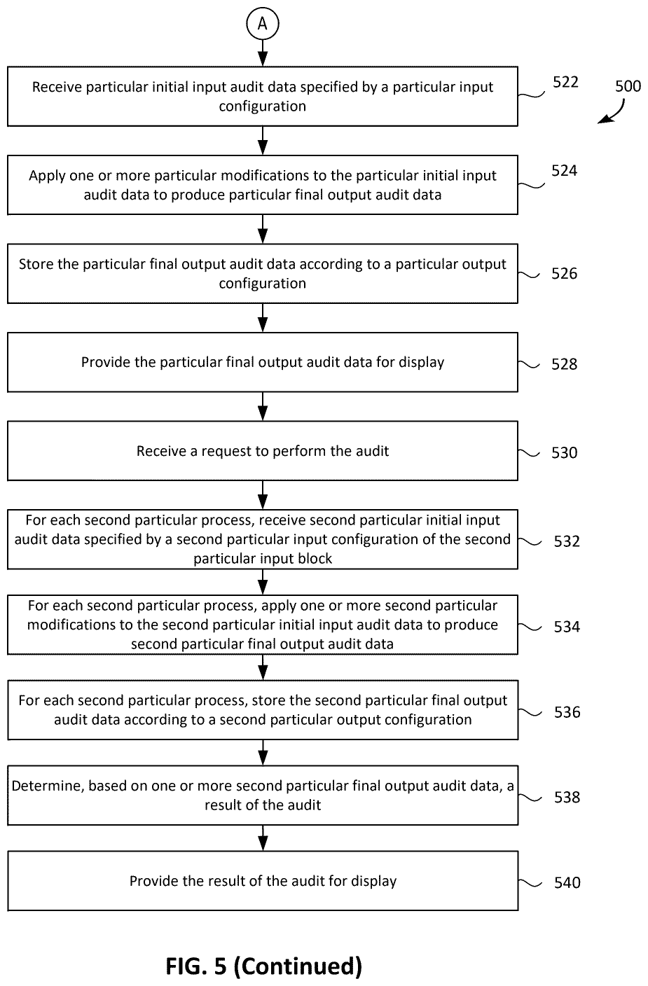

FIG. 5 is a flow diagram depicting method 500 for providing output audit data and results of audits in some embodiments. Various components of the audit system 108 may perform the method 500. The audit system 108 may perform some or all of the method 500 to allow users of the audit system 108 to create audits, create process flows, associate process flows with audits, and request that the audit system 108 execute process flows. The audit system 108 may also perform some or all of the method 500 to allow users of the audit system 108 to request that the audit system 108 execute audits.

The method 500 begins at step 502, where the audit system 108 (for example, the user interface module 206) receives a request to create an audit. The request may also specify a name of the audit and a party to be audited.

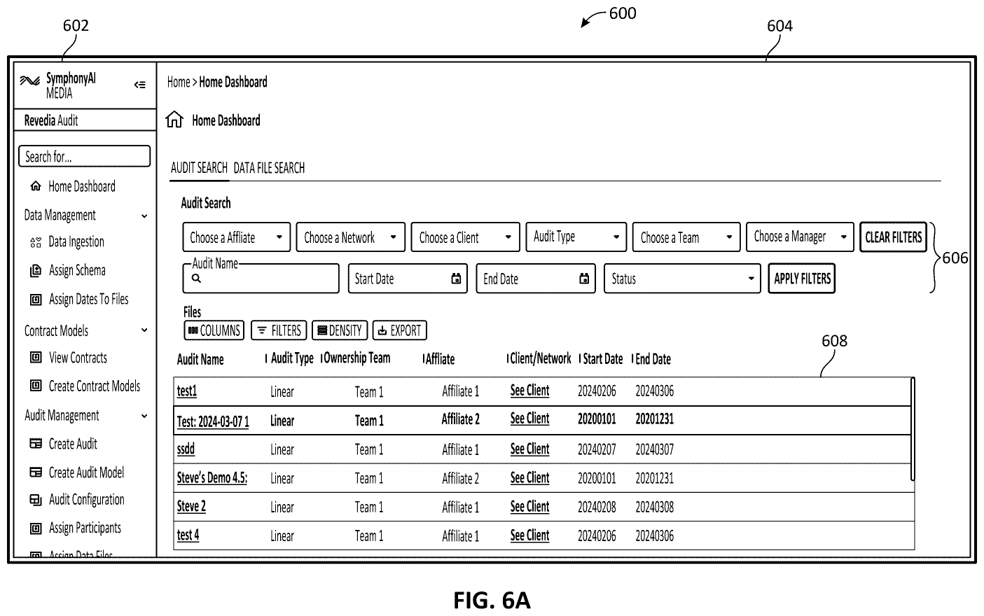

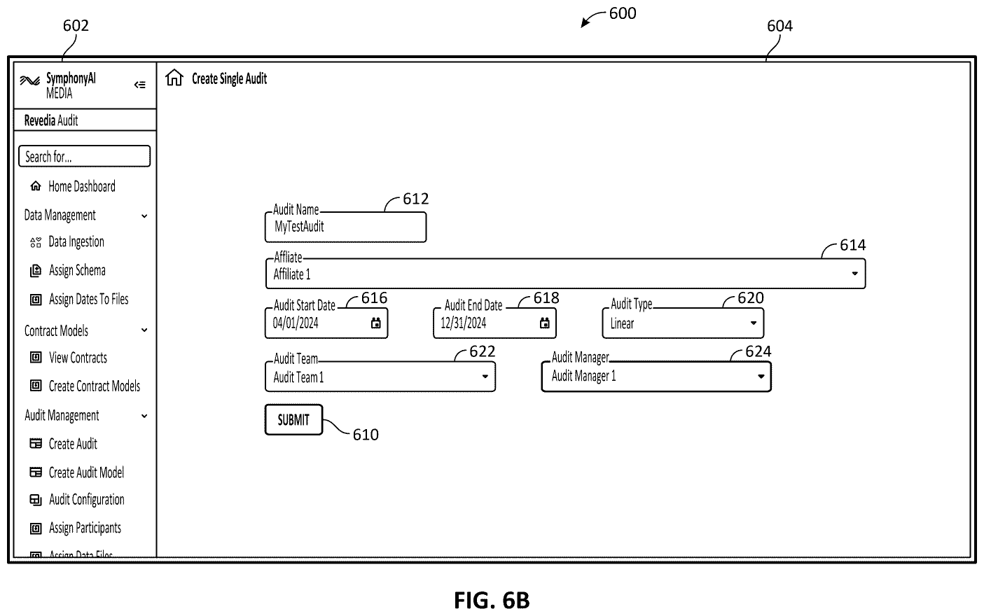

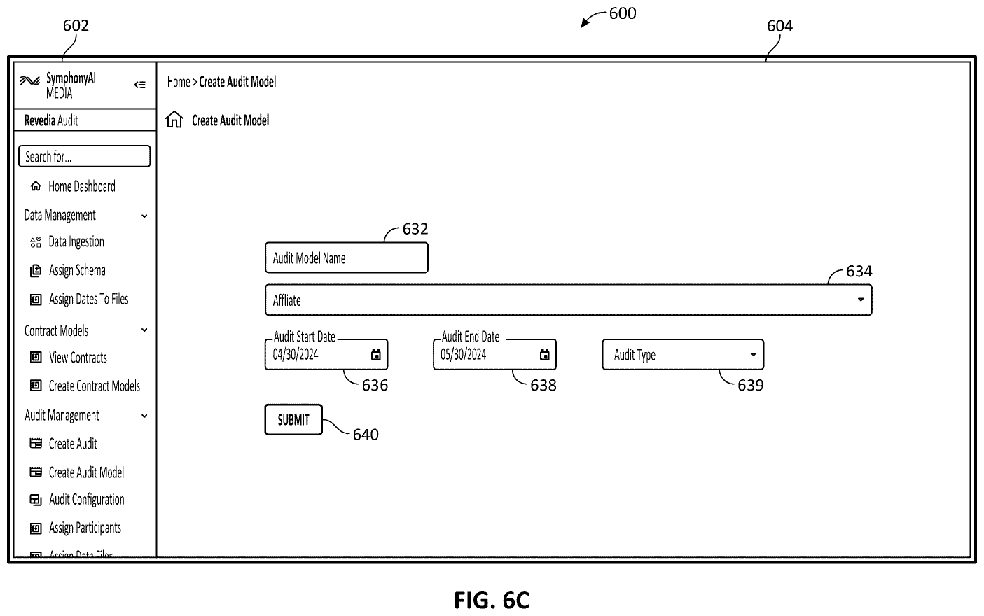

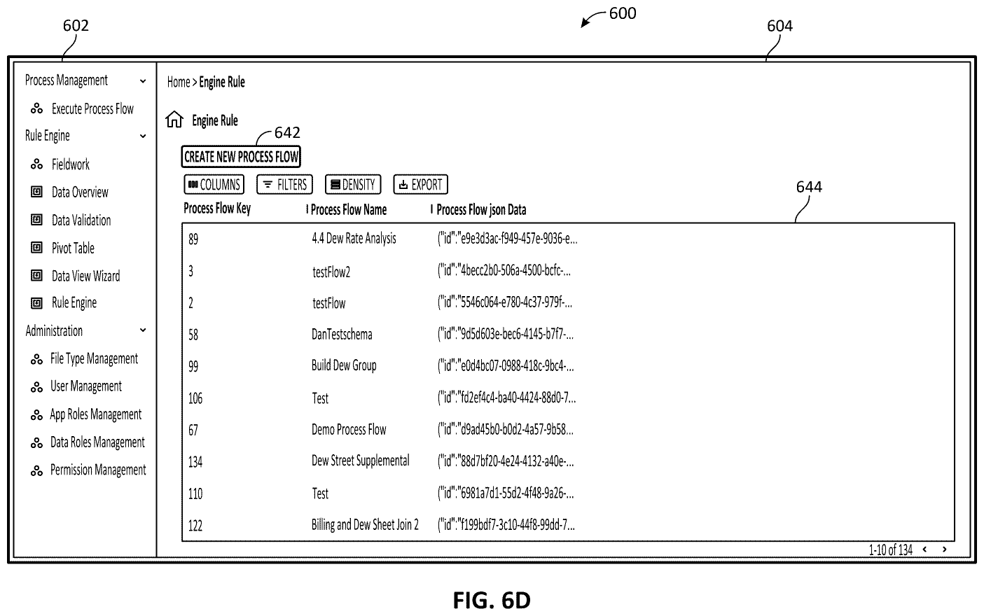

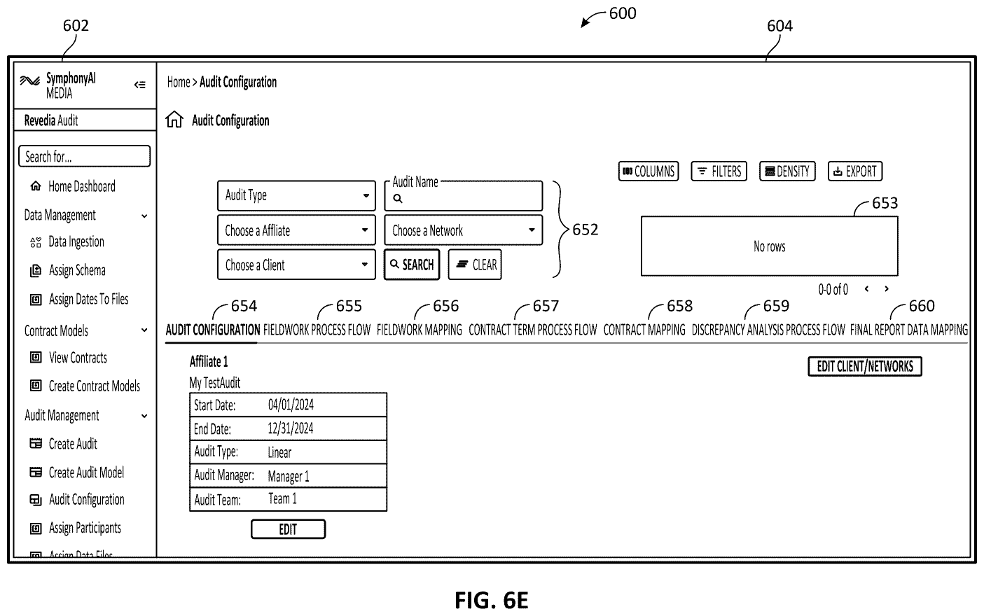

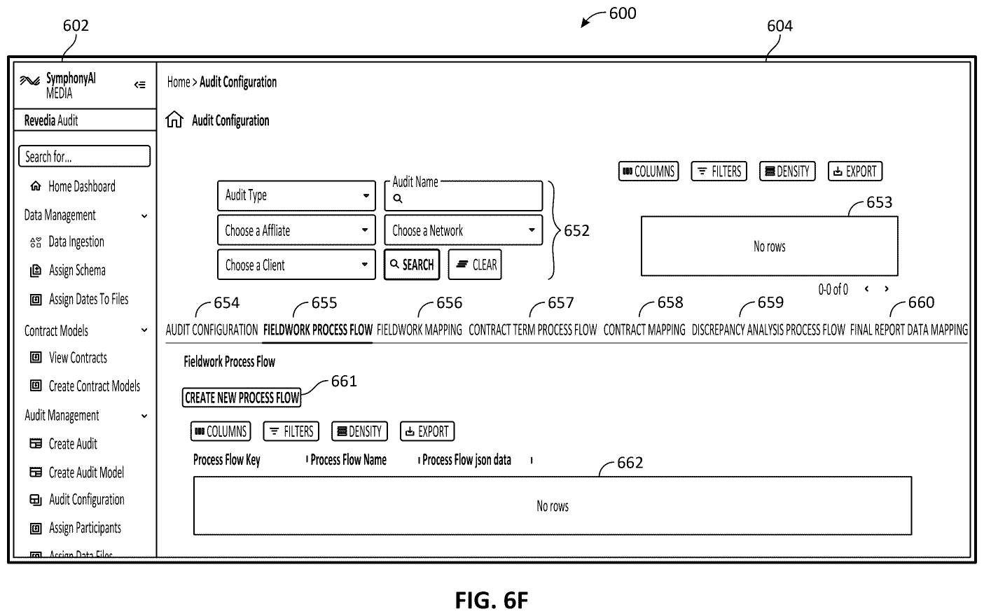

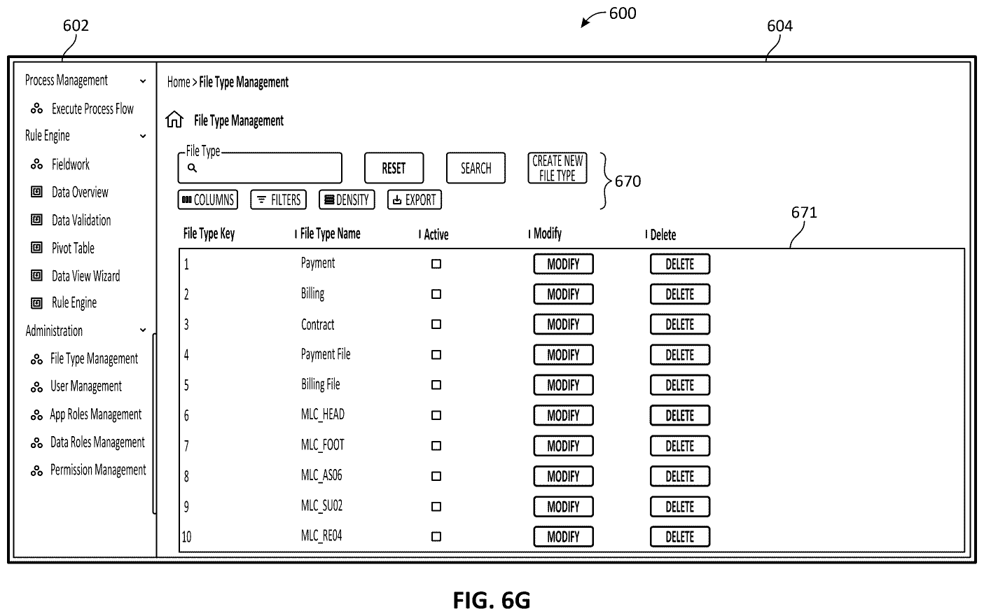

FIGS. 6A-6C depict example user interfaces that the audit system 108 may provide to allow users to view details about existing audits, search for existing audits based on various parameters, create audits, and create audit models. FIG. 6A depicts an interface 600 that includes a navigation section 602 and a main section 604. The navigation section 602 includes organized links to functionality provided by the audit system 108. The main section 604 includes user interface elements 606 that allow a user to search for audits and a table 608 that displays details about existing audits.

FIG. 6B displays the interface 600 after a user has selected the “Create Audit” link in the navigation section 602. The main section 604 displays a text field 612 in which the user can provide an audit name, a dropdown 614 allowing the user to select an affiliate, a date picker 616 allowing the user to select an audit start date, a date picker 618 allowing the user to select an audit end date, and a dropdown 620 allowing the user to select an audit type. In some embodiments, the available audit types are “Linear,” corresponding to traditional cable television, “Digital,” corresponding to content delivered over the Internet, and “Music,” corresponding to music. The main section 604 also displays a dropdown 622 allowing the user to select an audit team and a dropdown 624 allowing the user to select an audit manager. After specifying these details the user can select the button 610 labeled “Submit” to submit the details and request that the audit system 108 create the audit.

FIG. 6C displays the interface 600 after a user has selected the “Create Audit Model” link in the navigation section 602. The main section 604 displays a text field 632 in which the user can provide an audit model name, a dropdown 634 allowing the user to select an affiliate, a date picker 636 allowing the user to select an audit start date, a date picker 638 allowing the user to select an audit end date, and a dropdown 639 allowing the user to select an audit type. After specifying these details the user can select the button 640 labeled “Submit” to submit the details and request that the audit system 108 create the audit model. In some embodiments, the user may create an audit model which acts as a template for audits, meaning that such audits may inherit attributes of the audit model.

Returning to FIG. 5, at step 504 the audit system 108 (for example, the user interface module 206) receives one or more requests for one or more processes to be created for an audit, such as an audit created via the interface 600 displayed in FIG. 6B. FIG. 6D displays the interface 600 after the user has selected the “Rule Engine” link in the navigation section 602. The main section 604 displays a panel 644 which contains a list of existing processes and a button 642 labeled “Create New Process Flow.” Selecting the button 642 allows the user to request that the audit system 108 create a new process. The user may then request that the audit system 108 associate the created new process with one or more audits.

FIG. 6E depicts the interface 600 after the user has selected the “Audit Configuration” link in the navigation section 602. The main section 604 includes user interface elements 652 that allow the user to search for audits based on various parameters. The main section 604 also includes a user interface element 653 that displays matching audits.

The main section 604 also includes multiple tabs that when selected provide information about aspects of audits. The multiple tabs include an audit configuration tab 654, a fieldwork process flow tab 655, a fieldwork mapping tab 656, a contract term process flow tab 657, a contract mapping tab 658, a discrepancy analysis process flow tab 659, and a final report data mapping tab 660. FIG. 6E depicts configuration information for an audit that the audit system 108 provides when the user selects the audit configuration tab 654. FIG. 6F depicts fieldwork process flow information for an audit that the audit system 108 provides when the user selects the fieldwork process flow tab 655. The panel 662 displays existing processes that are associated with the fieldwork process, if any. The user may select the button 661 labeled “Create New Process Flow” which allows the user to request that the audit system 108 create a new process and associate the created new process with the audit. FIG. 6G depicts the main section 604 after the user has selected the “File Type Management” link in the navigation section 602. The main section 604 includes user interface elements 670 that allow the user to search for file types based on various parameters. The main section 604 also includes a user interface element 671 that displays file types, such as payment file types, billing file types, and contract file types. The user may modify or delete file types and toggle whether a file type is active. A file that the audit system 108 receives may have a file type as defined by a user using the interface 600 as depicted in FIG. 6G.

Returning to FIG. 5 the audit system 108, for each process the user requests to be created for the audit, performs step 506 through step 518. At step 506 the audit system 108 (for example, the user interface module 206) provides for display multiple blocks for selection by the user. The multiple blocks include an input block, multiple modification blocks, and an output block. An input block includes configuration information specifying input audit data, which may be a file, such as an Apache Parquet file, that is to be taken in by a process. An output block includes configuration information specifying a name of an output audit data file, which may be a filename, such as an Apache Parquet filename, that is to be the name of a file containing output audit data.

As discussed in more detail herein, a modification block takes intermediate input audit data and either filters, transforms, aggregates, combines, or otherwise modifies the intermediate input audit data to produce intermediate output audit data. Examples of modification blocks include filter blocks that filter audit data to produce filtered audit data, function blocks that apply at least one function to audit data to produce transformed audit data, data aggregation blocks that aggregate audit data to produce aggregated audit data, and data combination blocks that combine audit data to produce combined audit data. Other examples of modification blocks will be apparent.

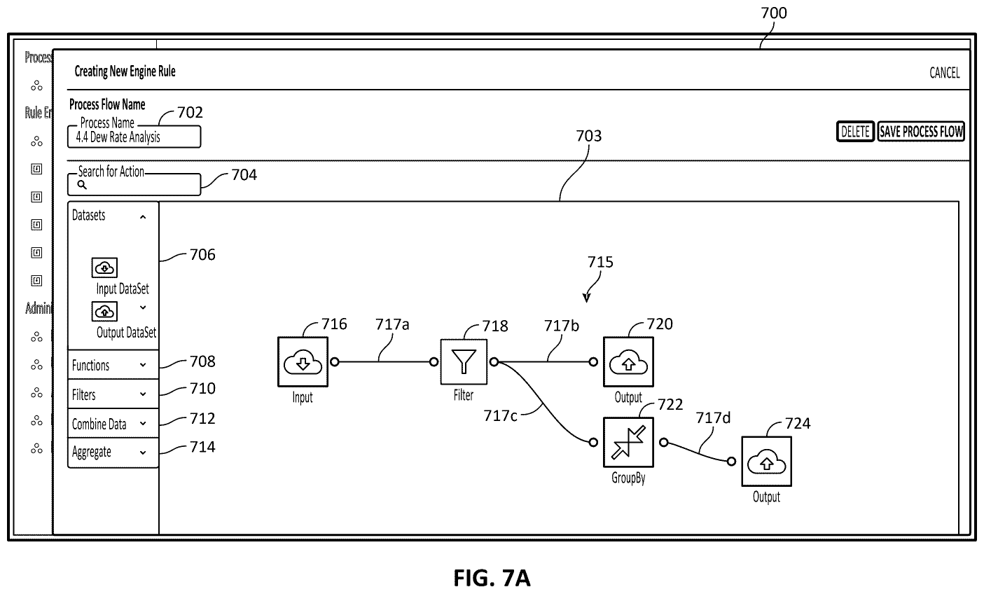

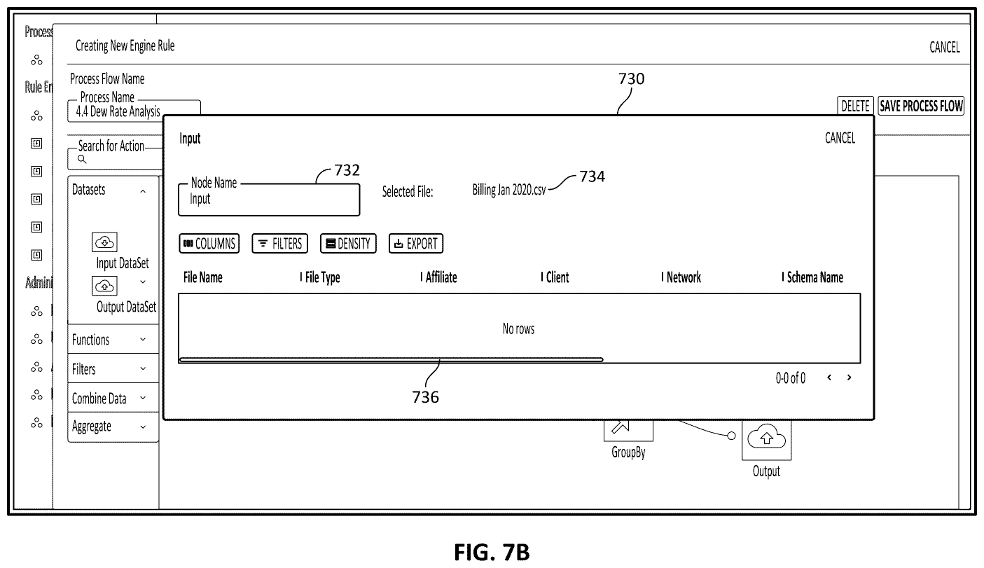

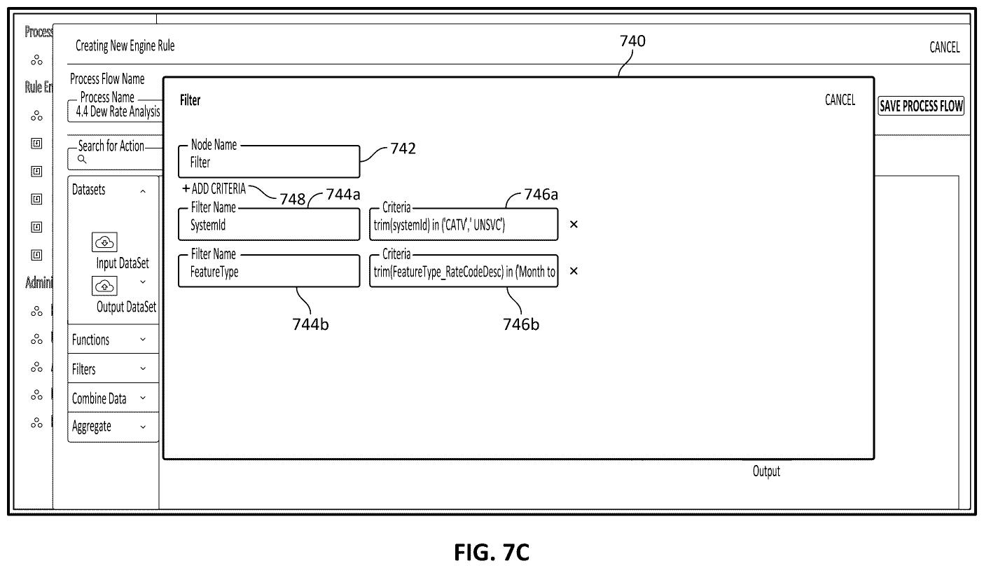

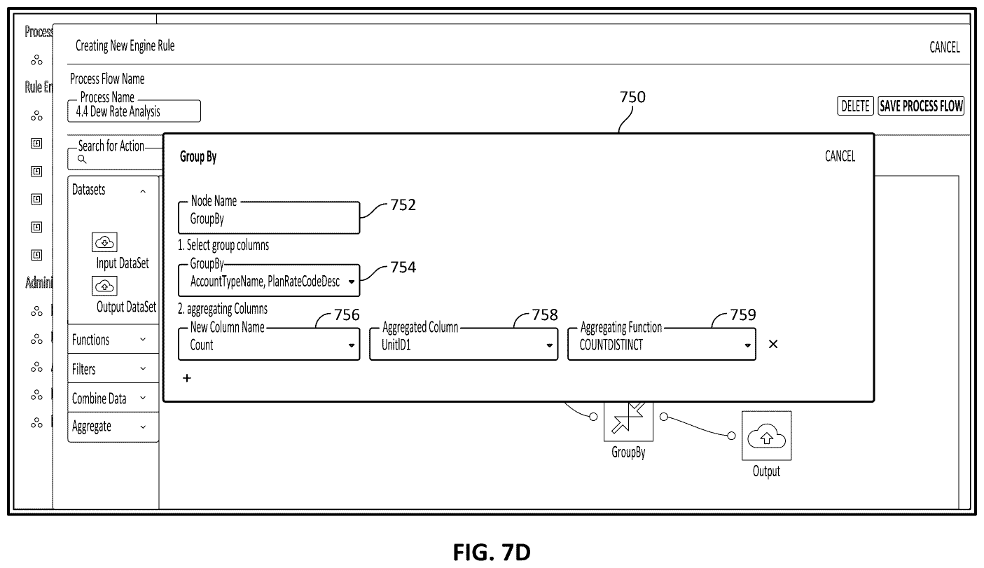

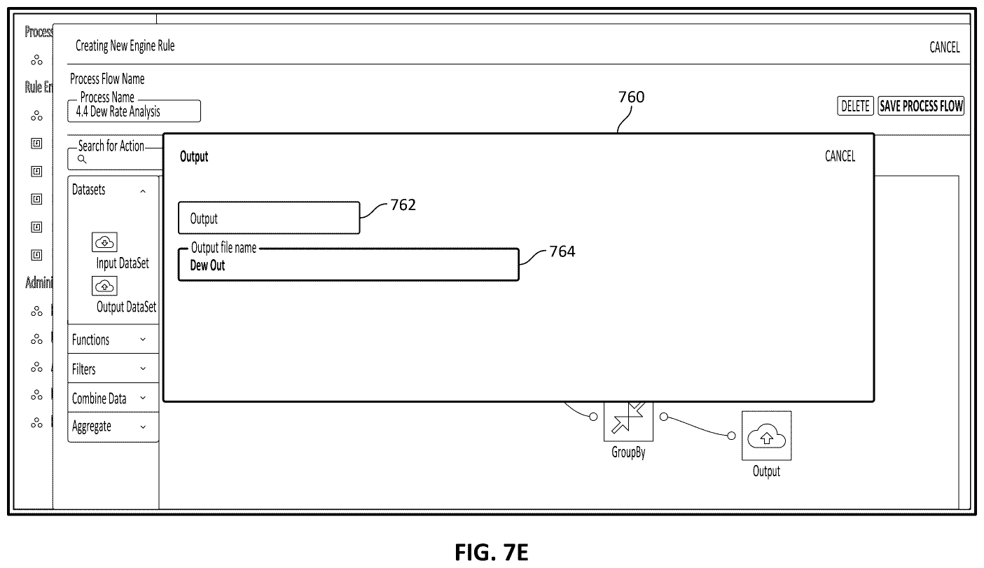

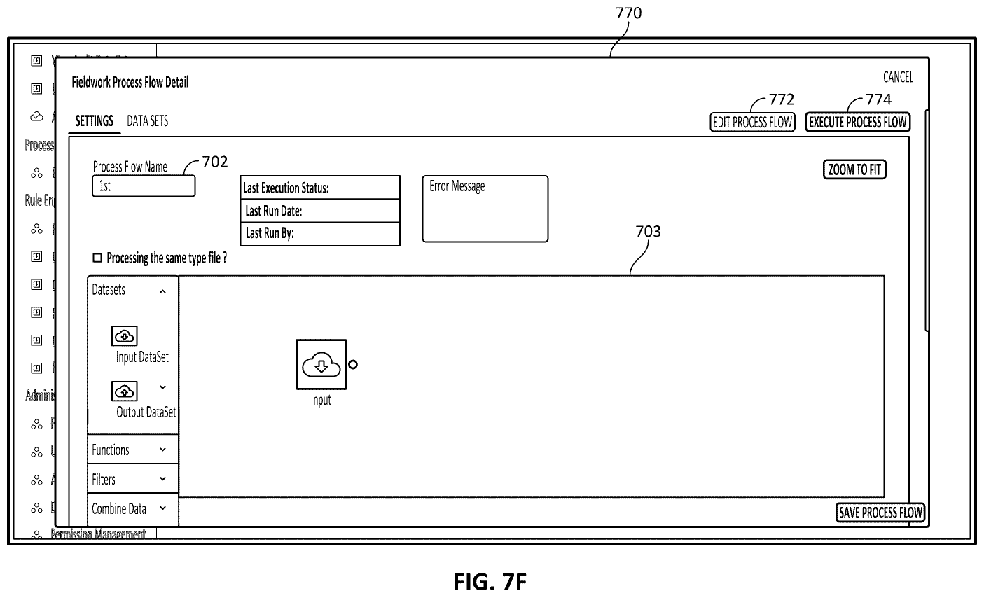

FIGS. 7A-7E depict example user interfaces that the audit system 108 may provide for display of multiple blocks for selection by the user and for configuration by the user. The audit system 108 provides such interfaces to allow the user to easily and quickly create process flows to be associated with audits.

FIG. 7A depicts an example interface 700 that the audit system 108 may provide for display after the user selects the button 661 in FIG. 6F or the button 642 in FIG. 6D to request that the audit system 108 create a new process. The user may provide a name for the process in text field 702. The user may select blocks from the datasets section 706, the functions section 708, the filters section 710, the combine data section 712, and/or the aggregate section 714. The interface 700 depicts an input block and an output block in the datasets section 706. The modification blocks may be found in the functions section 708, the filters section 710, the combine data section 712, and the aggregate section 714. The user may select one or more modification blocks by expanding one or more of these sections. The user may search for blocks using the search text field 704.

The interface 700 includes a user interface element 703 into which the user may drag and drop blocks and connectors. The user may select a block and then drag and drop the block into the user interface element 703. The user may also select a connector to be placed between two blocks and drag and drop the connector between the two blocks, thereby connecting the two blocks. A connector may function so as provide that the intermediate output audit data from a block to which the connector is attached becomes the intermediate input audit data to the other block to which the connector is attached.

The user interface element 703 displays a process flow 715 that includes an input block 716, a first output block 720 and a second output block 724. The process flow 715 also includes two modification blocks: a filter block 718 and an aggregation block 722. A connector 717a connects the input block 716 and the filter block 718, a connector 717b connects the filter block 718 and the first output block 720, a connector 717c connects the filter block 718 and the aggregation block 722, and a connector 717d connects the second output block 724. The connector 717c provides that the intermediate output audit data of the filter block 718 becomes the intermediate input audit data block of the aggregation block 722.

It will be appreciated that a process may include one or more input blocks and/or one or more output blocks. Furthermore, a process may not necessarily include an output block. For example, a user may wish to see intermediate output audit data produced by a modification block without having to specify an output block and output configuration for storing final output audit data.

Returning to FIG. 5, at step 508 the audit system 108 (for example, the user interface module 206) receives a selection of an input block and an input configuration for the input block. The input configuration specifies initial input audit data associated with the party to be audited. FIG. 7B depicts an interface 730 that the audit system 108 may provide for display if the user selects an input block. The user can specify a name of the input block in a text field 732. The user interface element 736 may display files that that the user can select as input audit data, such as the file 734. At step 510 the audit system 108 (for example, the audit process module 204) adds the selected input block to the process.

At step 512 the audit system 108 (for example, the user interface module 206) receives one or more selections of one or more modification blocks and one or more modification configurations for the one or more modification blocks. The one or more modification configurations specify one or more modifications to be made to data received by the one or more modification blocks. FIG. 7C depicts an interface 740 that the audit system 108 (for example, the user interface module 206) may provide for display when the user selects a modification block that is a filter block. The interface 740 includes a text field 742 in which the user may specify a filter name. The user may add filter criteria by selecting the link 748 labeled “Add Criteria.” The interface 740 depicts two criteria. A first criterion has a first name 744a and a first criterion 746a, and a second criterion has a second name 744b and a second criterion 746b. The first criterion 746a and the second criterion 746b specify operations that the audit system 108 is to perform on data. For example, a criterion may specify a filter operation that filters out certain data. In some embodiments, a criterion may be specified in a language or syntax that is generally similar or the same as Structured Query Language (SQL).

FIG. 7D depicts an interface 750 that the audit system 108 (for example, the user interface module 206) may provide for display when the user selects a modification block that is an aggregation block. The interface 750 includes a text field 752 in which the user may specify a name for the aggregation block. The interface 750 also includes a dropdown 754 which allows the user to select columns to be grouped, a dropdown 756 which allows the user to specify a new column name, a dropdown 758 which allows the user to specify an aggregated column, and a dropdown 759 which allows the user to specify an aggregating function. For example, the aggregating function may be a count of distinct values. Returning to FIG. 5, at step 514 the audit system 108 (for example, the audit process module 204) adds the one or more selected modification blocks to the process.

At step 516, the audit system 108 (for example, the user interface module 206) receives a selection of an output block and an output configuration for the output block. FIG. 7E depicts an interface 760 that the audit system 108 may provide for display if the user selects an output block. The user can specify a name of the output block in a text field 762 and a name of an output file in a text field 764. At step 518 the audit system 108 (for example, the audit process module 204) adds the selected input block to the process.

At step 520 the audit system 108 (for example, the audit process module 204) receives a request to execute a particular process, such as a particular process associated with an audit. The particular process may include an input block, one or more modification blocks, and an output block. FIG. 7F depicts an interface 770 that is similar to the interface 700 depicted in FIG. 7A. The interface 770 includes a button 772 labeled “Edit Process Flow” and a button 774 labeled “Execute Process Flow.” The user may request that the audit system 108 execute a process by selecting the button 774. At step 522 the audit system 108 (for example, the audit process module 204) may then receive initial input audit data specified by an input configuration of an input block (for example, the file 734 shown in FIG. 7B specified for input block 716) shown in FIG. 7A.

The audit system 108 (for example, the audit process module 204) may then apply one or more modifications specified by one or more modification configurations of one or more modification blocks (for example, the modifications specified by the modification configurations of the filter block 718 and the aggregation block 722) to the initial input audit data at a step 524. The audit system 108 may thus produce final output audit data and store the final output audit data according to the output configuration of the output block (for example, using the output file name specified in text field 764 shown in FIG. 7E) at step 526. The audit system 108 (for example, the audit process module 204) may store the final output audit data (for example, in the data storage 220). At a step 528 the audit system 108 (for example, the user interface module 206) may provide the final output audit data for display to the user.

According to some embodiments, the audit system 108 may allow a user to request that the audit system 108 perform an audit. The audit system 108 performing an audit may refer to the audit system 108 executing all the processes associated with the audit. At step 530 the audit system 108 (for example, the user interface module 206) may receive a request from a user to perform an audit. The audit system 108 (for example, the audit process module 204) may perform step 532 through step 536 for each process of the audit. In some embodiments, the audit system 108 (for example, the audit process module 204) may perform step 532 through step 536 for each process of the audit other than processes that the audit system 108 has already executed.

At step 532, the audit system 108 (for example, the audit process module 204) may receive initial input audit data specified by an input configuration of the input block of the process. At step 534, the audit system 108 (for example, the audit process module 204) may apply one or more modifications specified by one or more modification configurations of one or more modification blocks to the initial input audit data to produce final output audit data. The audit system 108 (for example, the audit process module 204) at step 536 may store the final output audit data according to an output configuration of the output block (for example, in the data storage 220). At step 538 the audit system 108 (for example, the audit process module 204) may determine, based on one or more final output audit data, a result of the audit. The audit system 108 (for example, the audit process module 204) at step 540 may provide the result of the audit for display.

FIG. 9 depicts an example user interface 900 that the audit system 108 may provide in some embodiments to show one or more results of one or more audits. The audit system 108 may provide the user interface 900 for representatives or employees of a content owner. The user interface 900 includes a navigation section 902 and a table 910 displaying a list of audits 912 along with details of each audit. The details may include information such as the audit period, the status of the audit, the delivery date of the audit report, the network or distribution partner being audited, the total payments by the network or distribution partner, the total findings for the audit, and a variance expressed in percent. The total payments may be revenue, and the total findings may be an audited amount of the revenue, or what the revenue should be. The variance may be based on the total payments and the total findings. The user interface 900 may also include a panel 904 indicating the total number of audits completed, a panel 906 indicating the total amount of payments, and a panel 908 indicating the total variance for all audits performed for the content owner.

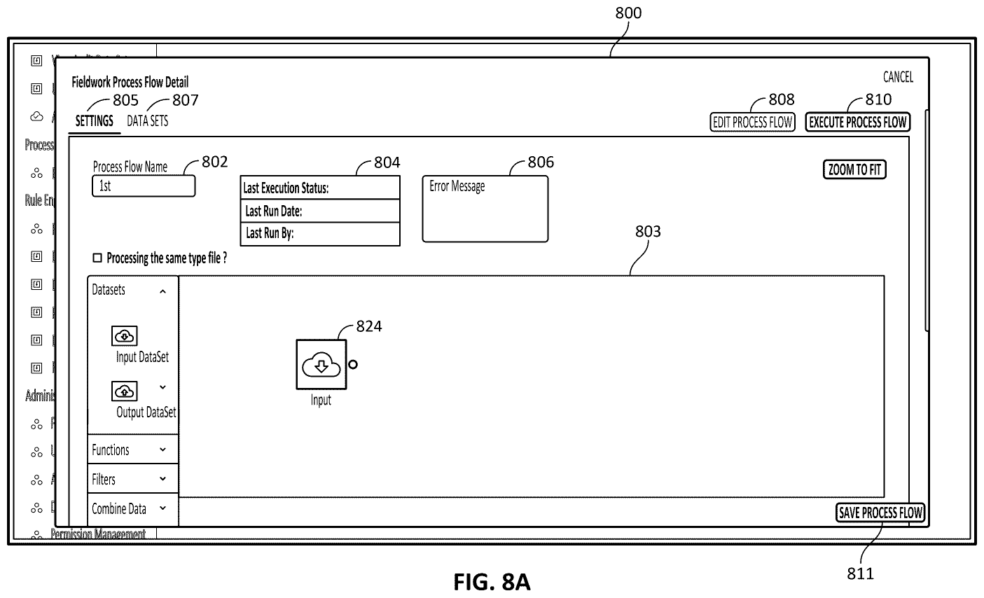

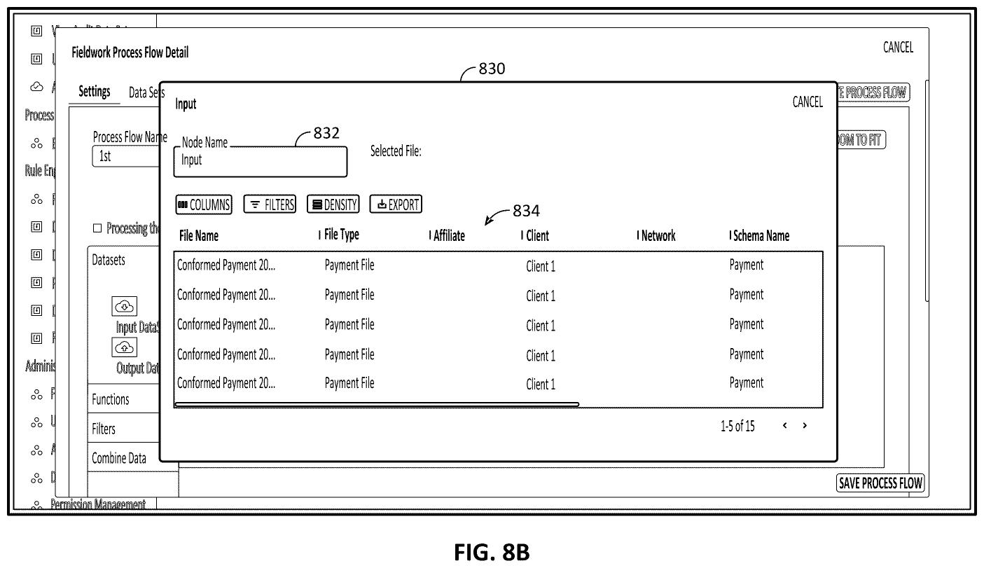

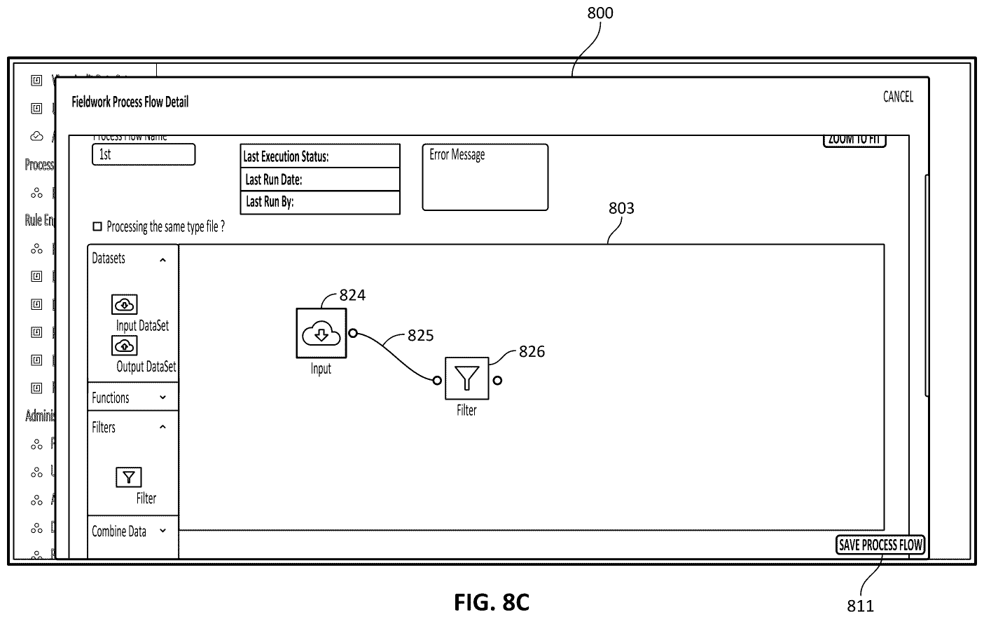

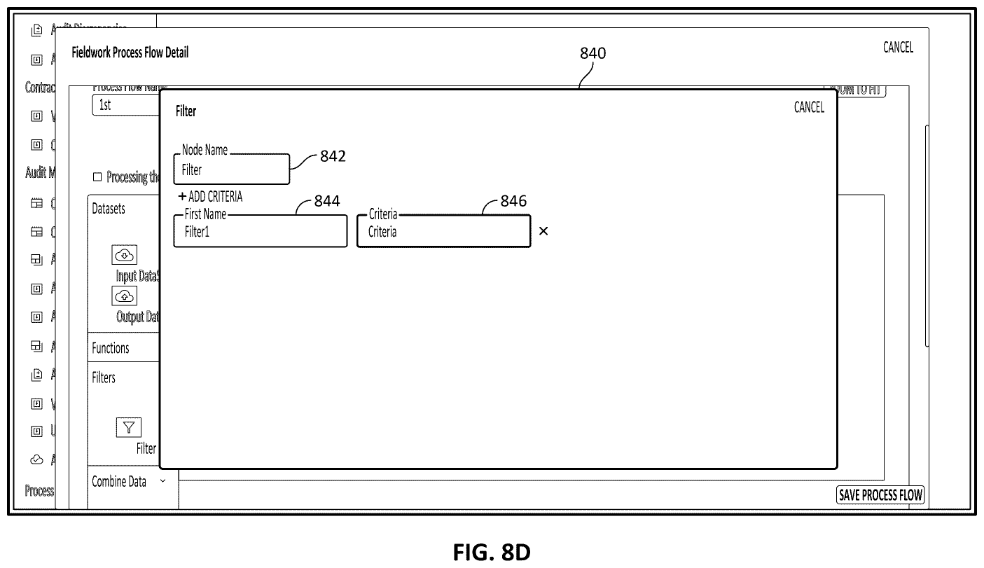

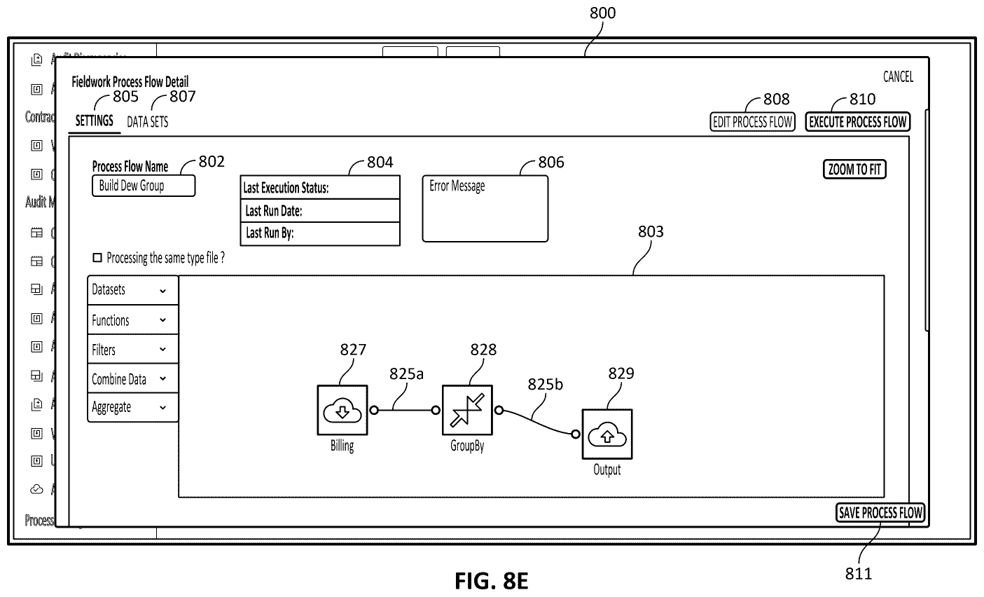

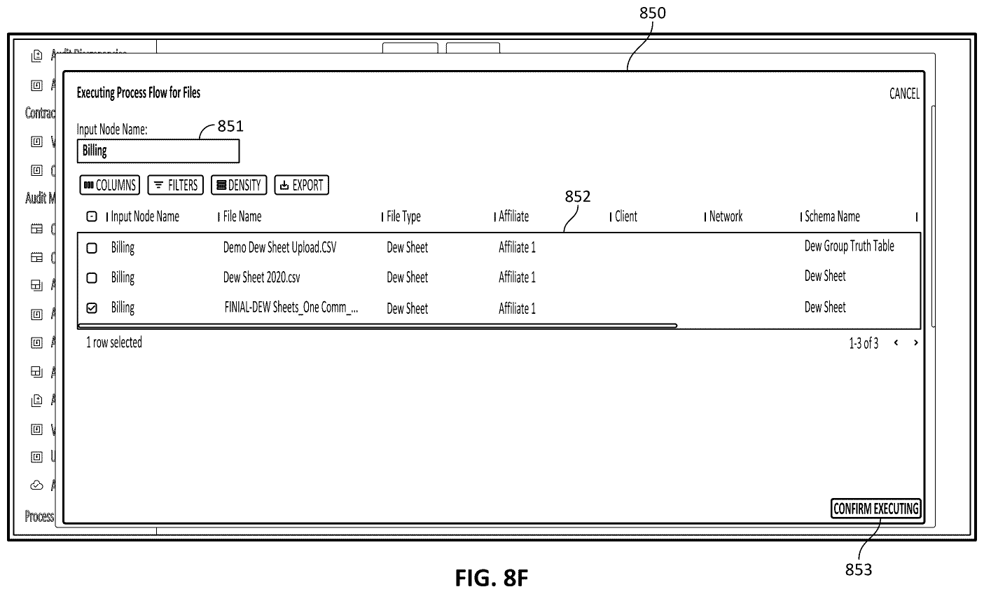

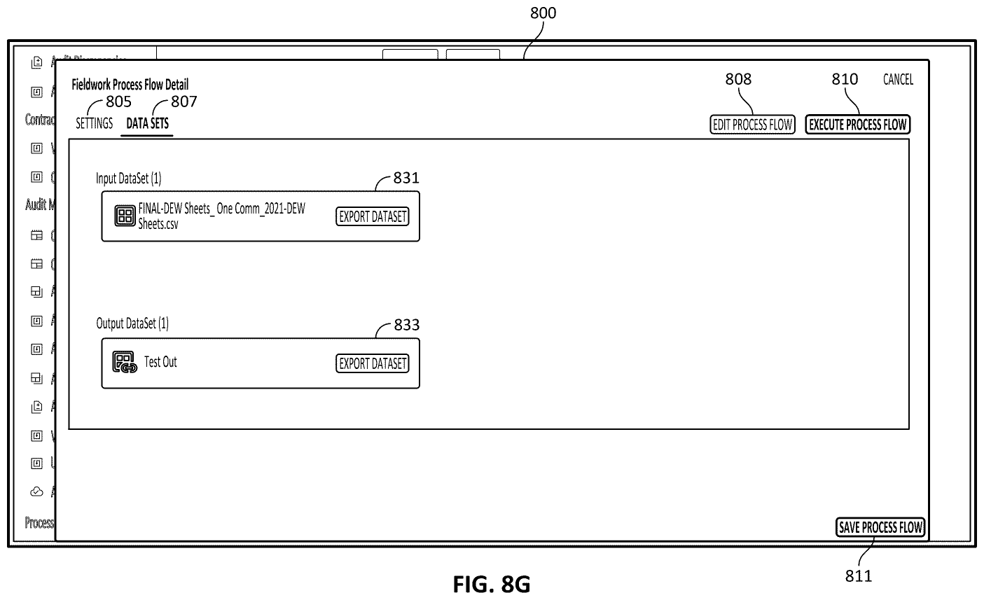

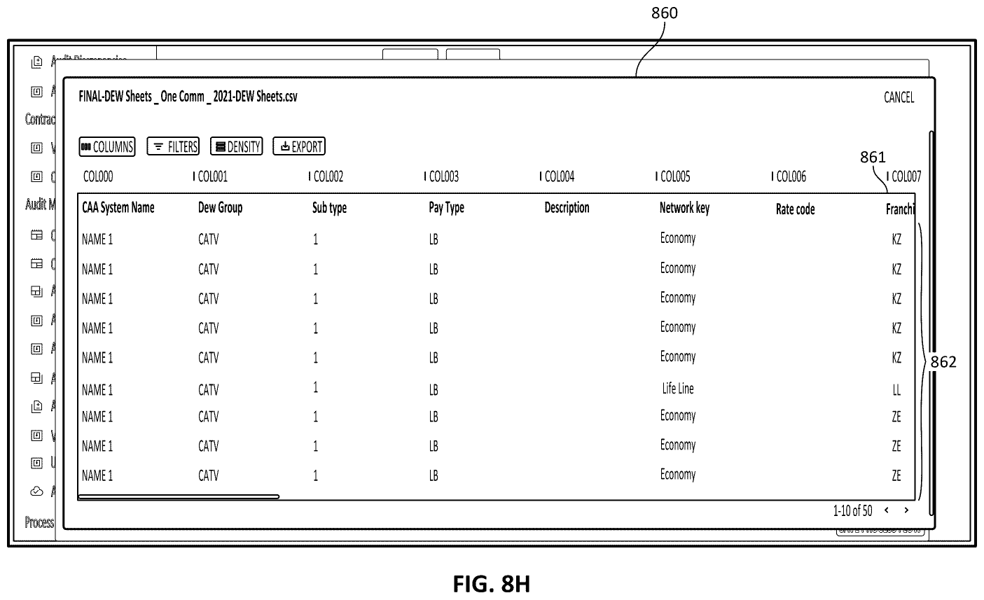

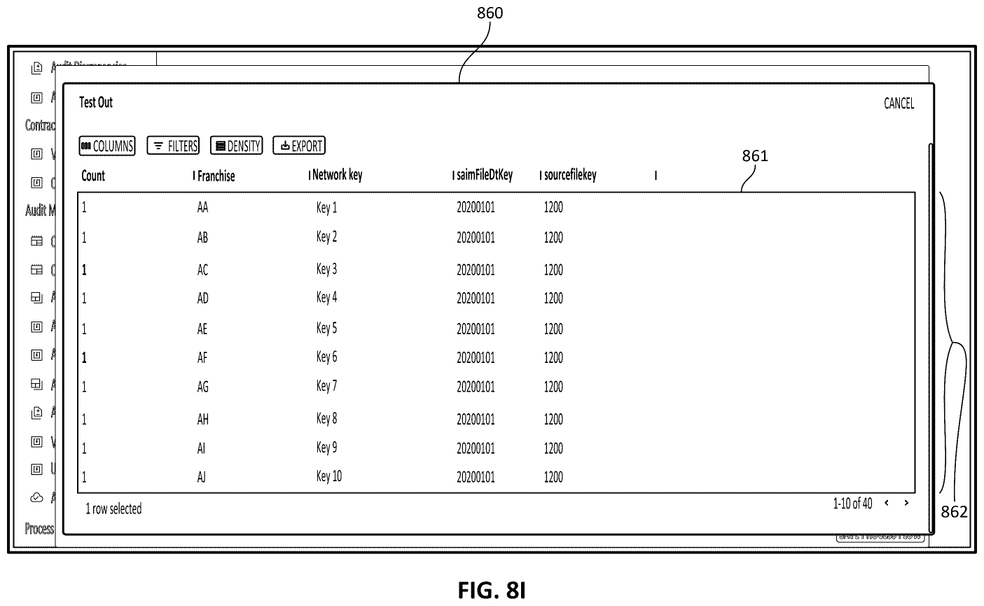

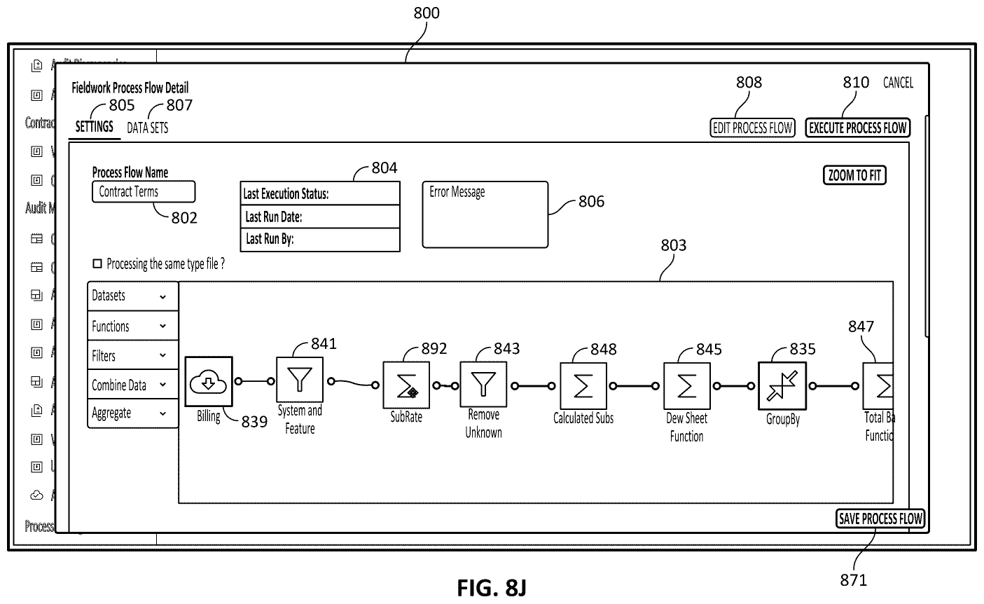

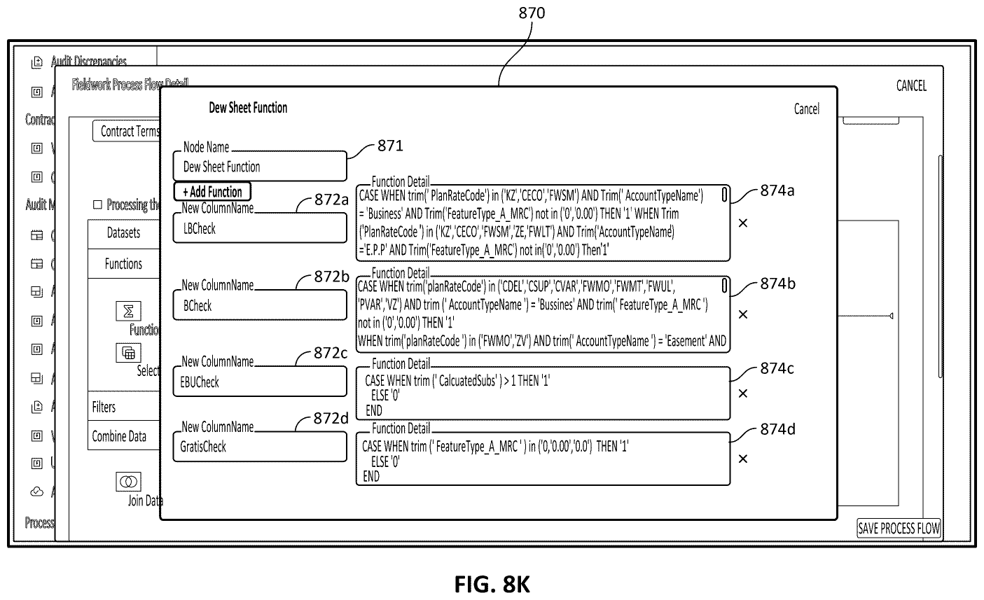

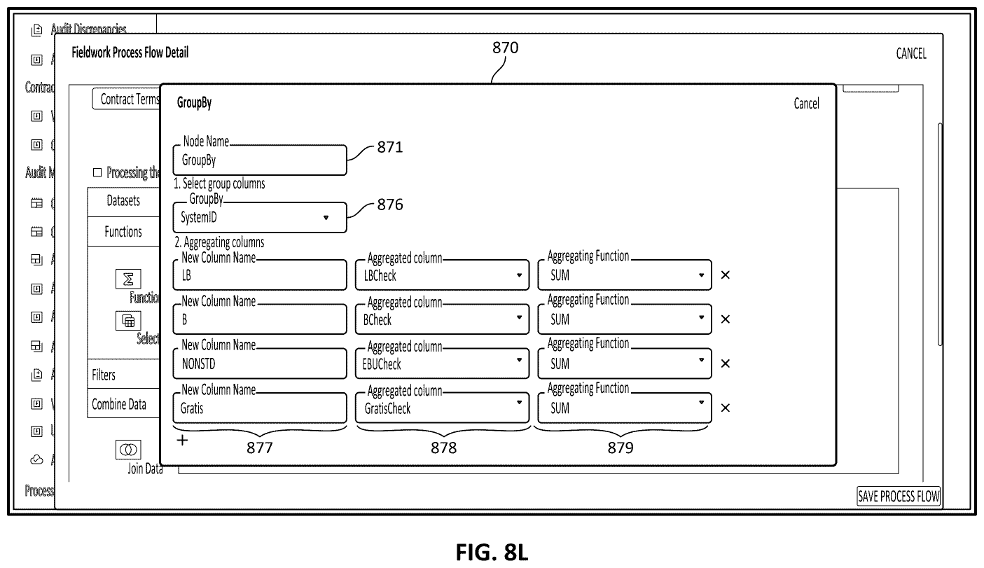

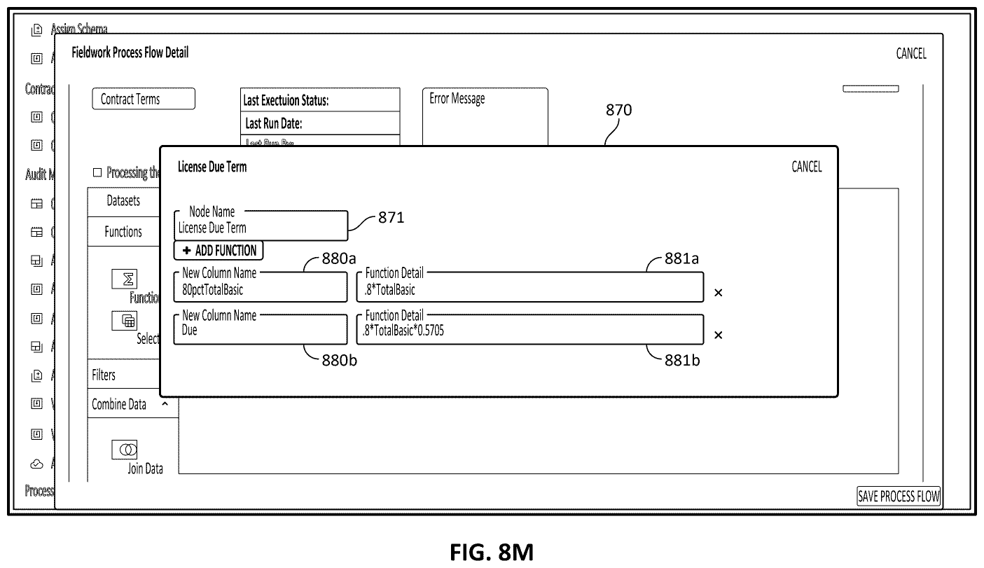

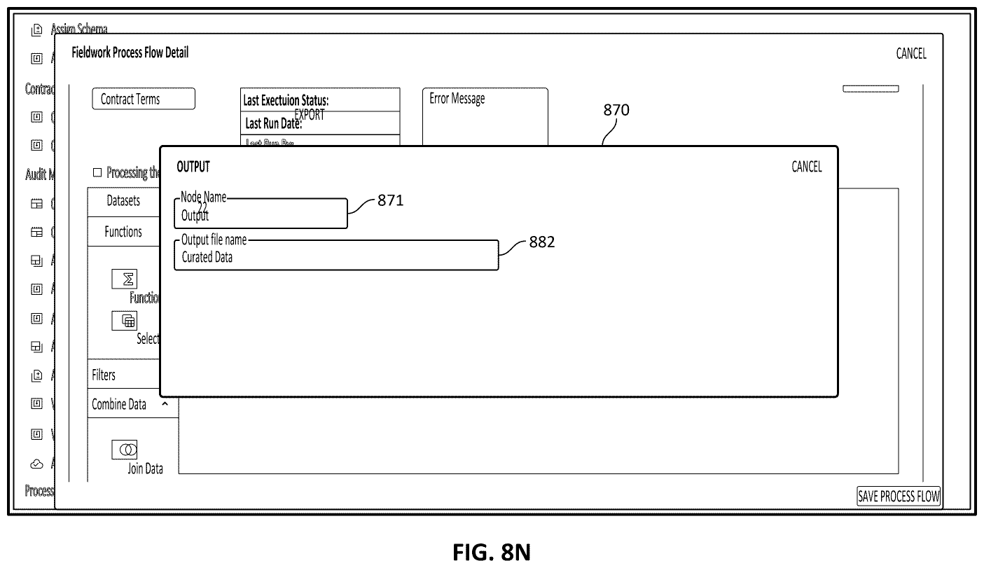

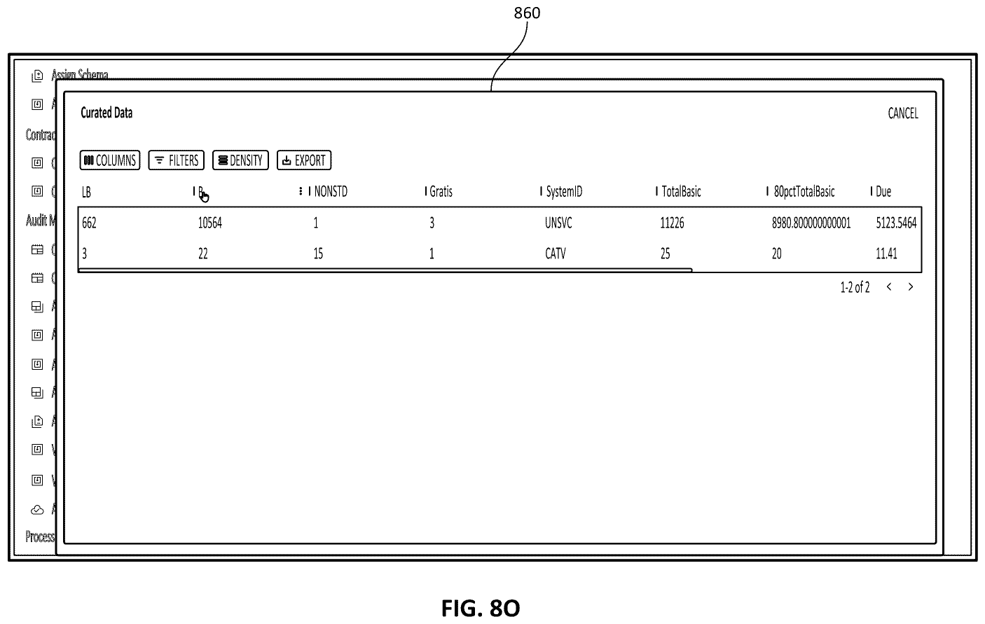

FIGS. 8A-8O depict additional example user interfaces provided by an audit system in some embodiments. FIG. 8A depicts an interface 800 that the audit system 108 (for example, the user interface module 206) may provide in response to a user request to create a process for an audit. The audit system 108 may provide the interface 800 for display when the user selects the button 661 shown in FIG. 6F. The interface 800 may include a tab 805 labeled “Settings” and a tab 807 labeled “Datasets.” The tab 805 may include a text field 802 where a user can specify a name for the process, a panel 804 that indicates details of when the audit system 108 last executed the process, and a panel 806 where the audit system 108 may provide messages regarding errors in the execution of the process, if any. The user may edit the process by selecting a button 808 labeled “Edit Process Flow,” save the process by selecting a button 811 labeled “Save Process Flow,” and execute the process by selecting a button 810 labeled “Execute Process Flow.”

The interface 800 also includes a user interface element 803 into which the user may drag and drop blocks. As shown, the user interface element 803 includes an input block 824. If the user selects the input block 824, the audit system 108 (for example, the user interface module 206) may provide an interface 830 as depicted in FIG. 8B. The user may specify a name of the input block in text field 832 and select a file as an input in user interface element 834. In FIG. 8C, the user interface element 803 includes the input block 824, a modification block 826 (a filter block), and a connector 825 connecting the input block 824 and the modification block 826. If the user selects the modification block 826, the audit system 108 (for example, the user interface module 206) may provide an interface 840 as depicted in FIG. 8D. The user may specify a name of the modification block in text field 842, a criterion name in text field 844 and a criterion in text field 846.

FIG. 8E depicts the user interface element 803 including an input block 827 labeled “Billing,” a modification block 828 labeled “GroupBy,” and an output block 829 along with a connector 825a between the input block 827 and the modification block 828 and a connector 825b between the modification block 828 and the output block 829. If the user selects the button 810, the audit system 108 (for example, the user interface module 206) may provide an interface 850 as depicted in FIG. 8F. The interface 850 includes a text field 851 with the input block name and a user interface element 852 listing multiple files that may be selected as an input file. The audit system 108 (for example, the user interface module 206) may provide the interface 850 to allow the user to confirm that a previously specified input file is to be used for the input audit data. After confirming the input file, the user may select a button 853 labeled “Confirm Executing” to request that the audit system 108 (for example, the audit process module 204) execute the process.

FIG. 8G depicts the interface 800 if the user has selected the tab 807 shown in FIG. 8A. The interface 800 includes an input dataset section 831 and an output dataset section 833. The user may select the input dataset section 831 to view the input dataset. FIG. 8H depicts an interface 860 showing the input dataset in a panel 861. The panel 861 includes rows 862 of the input dataset. The user may also select the output dataset section 833 in FIG. 8G to view the output dataset. FIG. 8I depicts the interface 860 showing the output dataset. The panel 861 includes rows 862 of the output dataset. The interface 860 thus allows the user to see input audit data and output audit data easily and quickly. This may allow the user to verify that the audit process is correctly analyzing and/or modifying the audit data and may aid the user in troubleshooting if required.

FIG. 8J depicts the interface 800 with the user interface element 803 including a different process that that shown in FIG. 8A. The process includes an input block 839 and multiple modification blocks, including modification block 841, modification block 892, modification block 843, modification block 848, modification block 845, modification block 835, and modification block 847. FIG. 8K depicts an interface 870 that the audit system 108 (for example, the user interface module 206) may provide after the user has selected the modification block 845 in FIG. 8J. The interface 870 includes a text field 871 where the user may provide a name for the modification block and may add a new function name and new code for the function. The interface 870 depicts a function name 872a and function code 874a, a function name 872b and function code 874b, a function name 872c and function code 874c, and a function name 872d and function code 874d. The user can specify complex functions to be performed on audit data and structure such functions so as to modify the audit data as required or desired.

FIG. 8L depicts the interface 870 that the audit system 108 (for example, the user interface module 206) may provide after the user has selected the modification block 835 in FIG. 8J. The interface includes a dropdown 876 which allows the user to select columns to be grouped. The user may specify new column names in text fields 877, aggregated columns in dropdowns 878, and aggregating functions in dropdowns 879. The user may thus specify functions to be performed on audit data in various different columns.

FIG. 8M depicts the interface 870 that the audit system 108 (for example, the user interface module 206) may provide after the user has selected a modification block such as the modification block 892 or the modification block 848 in FIG. 8J. The interface 870 depicts a first new column name 880a and corresponding first function 881a and a second new column name 880b and corresponding first function 881b. The user can specify a name of the modification block in the text field 871. FIG. 8N depicts the interface 870 after the user selects an output block. The user can specify a name of the output block in the text field 871 and an output file name in text field 882. FIG. 8O depicts the interface 860 depicting audit output data. The user may view audit output data by selecting, for example, the output dataset section 833. This allows the user to see final output data.

The audit system 108 may also allow a user to see intermediate output audit data. For example, the user may connect an output block to an intermediate modification block that is not the last modification block in a process. The user may then select the output block to see the intermediate output audit data from the intermediate modification block. As another example, the audit system 108 may provide a link to intermediate output audit data of a modification block in the interface that the audit system 108 provides when the selects the modification block. Other ways that the audit system 108 may provide intermediate output audit data to users will be apparent.

FIG. 10 depicts a block diagram of an example digital device 1000 according to some embodiments. The digital device 1000 is shown in the form of a general-purpose computing device. The digital device 1000 includes at least one processor 1002, RAM 1004, communication interface 1006, input/output device 1008, storage 1010, and a system bus 1012 that couples various system components including storage 1010 to the at least one processor 1002. A system, such as a computing system, may be or include one or more of the digital device 1000.

System bus 1012 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1000 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1002 is configured to execute executable instructions (for example, programs). In some embodiments, the at least one processor 1002 comprises circuitry or any processor capable of processing the executable instructions.

In some embodiments, RAM 1004 stores programs and/or data. In various embodiments, working data is stored within RAM 1004. The data within RAM 1004 may be cleared or ultimately transferred to storage 1010, such as prior to reset and/or powering down the digital device 1000.

In some embodiments, the digital device 1000 is coupled to a network, such as the communication network 102, via communication interface 1006. The digital device 1000 can communicate with one or more networks such as a local area network (LAN), a general wide area network (WAN), and/or a public network (for example, the Internet).

In some embodiments, input/output device 1008 is any device that inputs data (for example, mouse, keyboard, stylus, sensors, etc.) or outputs data (for example, speaker, display, virtual reality headset).

In some embodiments, storage 1010 can include computer system readable media in the form of non-volatile memory, such as read only memory (ROM), programmable read only memory (PROM), solid-state drives (SSD), flash memory, and/or cache memory. Storage 1010 may further include other removable/non-removable, volatile/non-volatile computer system storage media. By way of example only, storage 1010 can be provided for reading from and writing to a non-removable, non-volatile magnetic media. The storage 1010 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1012 by one or more data media interfaces. As will be further depicted and described below, storage 1010 may include at least one program product having a set (for example, at least one) of program modules that are configured to carry out the functions of embodiments of the invention. In some embodiments, RAM 1004 is found within storage 1010.

Programs/utilities, having a set (at least one) of program modules, such as the audit system 108, may be stored in storage 1010 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1000. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, although auditing of revenue associated with content may be described, the systems and methods described herein may be applicable to auditing of revenue from any source.

Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving a request to create an audit, the request specifying a party to be audited;
receiving one or more requests to create one or more processes for the audit;
for each process of the one or more processes:
providing for display multiple blocks for selection, the multiple blocks including an input block, multiple modification blocks, and an output block;
receiving a selection of an input block and an input configuration for the input block, the input configuration specifying initial input audit data associated with the party;
adding the input block to the process;
receiving one or more selections of one or more modification blocks and one or more modification configurations for the one or more modification blocks, the one or more modification configurations specifying one or more modifications to be made to data received by the one or more modification blocks;
adding the one or more modification blocks to the process;
receiving a selection of an output block and an output configuration for the output block; and
adding the output block to the process;
receiving a request to execute a particular process of the one or more processes, the particular process including a particular input block, one or more particular modification blocks, and a particular output block;
receiving particular initial input audit data specified by a particular input configuration of the particular input block;
applying one or more particular modifications specified by one or more particular modification configurations of the one or more particular modification blocks to the particular initial input audit data to produce particular final output audit data;
storing the particular final output audit data according to a particular output configuration of the particular output block; and
providing the particular final output audit data for display.

2. The non-transitory computer-readable medium of claim 1 wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

3. The non-transitory computer-readable medium of claim 1 wherein the method further comprises, for the particular process of the one or more processes:
receiving a request to view intermediate output data produced by a particular modification specified by a particular modification configuration of a particular modification block of the one or more particular modification blocks;
applying the particular modification to intermediate input audit data received by the particular modification block to produce intermediate output audit data; and
providing the intermediate output audit data for display.

4. The non-transitory computer-readable medium of claim 1 wherein the method further comprises, for each process of the one or more processes:
receiving a selection of a connector to be placed between a first block and a second block;
receiving a selection of the first block and the second block, and
connecting the first block and the second block with the connector, such that intermediate output audit data of the first block is to become intermediate input audit data of the second block.

5. The non-transitory computer-readable medium of claim 1 wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and the method further comprises:
receiving a request to perform the audit;
for each second particular process other than the first particular process of the one or more processes, a second particular process including a second particular input block, one or more second particular modification blocks, and a second particular output block:
receiving second particular initial input audit data specified by a second particular input configuration of the second particular input block;
applying one or more second particular modifications specified by one or more second particular modification configurations of the one or more second particular modification blocks to the second particular initial input audit data to produce second particular final output audit data; and
storing the second particular final output audit data according to a second particular output configuration of the second particular output block;
determining, based on one or more second particular final output audit data, a result of the audit; and
providing the result of the audit for display.

6. The non-transitory computer-readable medium of claim 5 wherein the audit is of revenue, and the method further comprises:
receiving an amount of the revenue;
determining, based on the one or more second particular final output audit data, an audited amount of the revenue; and
determining, based on the amount of the revenue and the audited amount of the revenue, the result of the audit.

7. The non-transitory computer-readable medium of claim 1 wherein the audit is a first audit, the particular input configuration is a first particular input configuration, the particular initial input audit data is first particular initial input audit data, the particular output configuration is a first particular output configuration, and the method further comprises:
receiving a request to create a second audit, the request specifying the party;
receiving a request to associate the particular process with the second audit;
receiving a second particular input configuration specifying second particular initial input audit data for the particular input block;
receiving a second particular output configuration for the particular output block;
receiving a request to execute the particular process for the second audit;
receiving the second particular initial input audit data specified by the second particular input configuration;
applying the one or more modifications specified by the one or more particular modification configurations of the one or more particular modification blocks to the second particular initial input audit data to produce second particular final output audit data;
storing the second particular final output audit data according to the second particular output configuration; and
providing the second particular final output audit data for display.

8. A method comprising:
receiving a request to create an audit, the request specifying a party to be audited;
receiving one or more requests to create one or more processes for the audit;
for each process of the one or more processes:
providing for display multiple blocks for selection, the multiple blocks including an input block, multiple modification blocks, and an output block;
receiving a selection of an input block and an input configuration for the input block, the input configuration specifying initial input audit data associated with the party;
adding the input block to the process;
receiving one or more selections of one or more modification blocks and one or more modification configurations for the one or more modification blocks, the one or more modification configurations specifying one or more modifications to be made to data received by the one or more modification blocks;
adding the one or more modification blocks to the process;
receiving a selection of an output block and an output configuration for the output block; and
adding the output block to the process;
receiving a request to execute a particular process of the one or more processes, the particular process including a particular input block, one or more particular modification blocks, and a particular output block;
receiving particular initial input audit data specified by a particular input configuration of the particular input block;
applying one or more particular modifications specified by one or more particular modification configurations of the one or more particular modification blocks to the particular initial input audit data to produce particular final output audit data;
storing the particular final output audit data according to a particular output configuration of the particular output block; and
providing the particular final output audit data for display.

9. The method of claim 8, wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

10. The method of claim 8, further comprising, for the particular process of the one or more processes:
receiving a request to view intermediate output data produced by a particular modification specified by a particular modification configuration of a particular modification block of the one or more particular modification blocks;
applying the particular modification to intermediate input audit data received by the particular modification block to produce intermediate output audit data; and
providing the intermediate output audit data for display.

11. The method of claim 8, further comprising, for each process of the one or more processes:
receiving a selection of a connector to be placed between a first block and a second block;
receiving a selection of the first block and the second block, and
connecting the first block and the second block with the connector, such that intermediate output audit data of the first block is to become intermediate input audit data of the second block.

12. The method of claim 8 wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and further comprising:
receiving a request to perform the audit;
for each second particular process other than the first particular process of the one or more processes, a second particular process including a second particular input block, one or more second particular modification blocks, and a second particular output block:
receiving second particular initial input audit data specified by a second particular input configuration of the second particular input block;
applying one or more second particular modifications specified by one or more second particular modification configurations of the one or more second particular modification blocks to the second particular initial input audit data to produce second particular final output audit data; and
storing the second particular final output audit data according to a second particular output configuration of the second particular output block;
determining, based on one or more second particular final output audit data, a result of the audit; and
providing the result of the audit for display.

13. The method of claim 12 wherein the audit is of revenue, and further comprising:
receiving an amount of the revenue;
determining, based on the one or more second particular final output audit data, an audited amount of the revenue; and
determining, based on the amount of the revenue and the audited amount of the revenue, the result of the audit.

14. The method of claim 8 wherein the audit is a first audit, the particular input configuration is a first particular input configuration, the particular initial input audit data is first particular initial input audit data, the particular output configuration is a first particular output configuration, and further comprising:
receiving a request to create a second audit, the request specifying the party;
receiving a request to associate the particular process with the second audit;
receiving a second particular input configuration specifying second particular initial input audit data for the particular input block;
receiving a second particular output configuration for the particular output block;
receiving a request to execute the particular process for the second audit;
receiving the second particular initial input audit data specified by the second particular input configuration;
applying the one or more modifications specified by the one or more particular modification configurations of the one or more particular modification blocks to the second particular initial input audit data to produce second particular final output audit data;
storing the second particular final output audit data according to the second particular output configuration; and
providing the second particular final output audit data for display.

15. A system comprising at least one processor and memory containing executable instructions, the executable instructions being executable by the at least one processor to:
receive a request to create an audit, the request specifying a party to be audited;
receive one or more requests to create one or more processes for the audit;
for each process of the one or more processes:
provide for display multiple blocks for selection, the multiple blocks including an input block, multiple modification blocks, and an output block;
receive a selection of an input block and an input configuration for the input block, the input configuration specifying initial input audit data associated with the party;
add the input block to the process;
receive one or more selections of one or more modification blocks and one or more modification configurations for the one or more modification blocks, the one or more modification configurations specifying one or more modifications to be made to data received by the one or more modification blocks;
add the one or more modification blocks to the process;
receive a selection of an output block and an output configuration for the output block; and
add the output block to the process;
receive a request to execute a particular process of the one or more processes, the particular process including a particular input block, one or more particular modification blocks, and a particular output block;
receive particular initial input audit data specified by a particular input configuration of the particular input block;
apply one or more particular modifications specified by one or more particular modification configurations of the one or more particular modification blocks to the particular initial input audit data to produce particular final output audit data;
store the particular final output audit data according to a particular output configuration of the particular output block; and
provide the particular final output audit data for display.

16. The system of claim 15 wherein the multiple modification blocks include one or more filter blocks, a filter block filtering audit data to produce filtered audit data, one or more function blocks, a function block applying at least one function to audit data to produce transformed audit data, one or more data aggregation blocks, a data aggregation block aggregating audit data to produce aggregated audit data, and one or more data combination blocks, a data combination block combining audit data to produce combined audit data.

17. The system of claim 15 wherein the executable instructions are further executable by the at least one processor to, for the particular process of the one or more processes:
receive a request to view intermediate output data produced by a particular modification specified by a particular modification configuration of a particular modification block of the one or more particular modification blocks;
apply the particular modification to intermediate input audit data received by the particular modification block to produce intermediate output audit data; and
provide the intermediate output audit data for display.

18. The system of claim 15 wherein the particular process is a first particular process, the particular initial input audit data is first particular initial input audit data, the particular input configuration is first particular input configuration, the one or more particular modifications specified by the one or more particular modification configurations of the one or more particular modification blocks is one or more first particular modifications specified by first one or more particular modification configurations of one or more first particular modification blocks, the particular final output audit data is first particular final output audit data, the particular output configuration is a first particular output configuration, the particular output block is a first particular output block, and the executable instructions are further executable by the at least one processor to:
receive a request to perform the audit;
for each second particular process other than the first particular process of the one or more processes, a second particular process including a second particular input block, one or more second particular modification blocks, and a second particular output block:
receive second particular initial input audit data specified by a second particular input configuration of the second particular input block;
apply one or more second particular modifications specified by one or more second particular modification configurations of the one or more second particular modification blocks to the second particular initial input audit data to produce second particular final output audit data; and
store the second particular final output audit data according to a second particular output configuration of the second particular output block;
determine, based on one or more second particular final output audit data, a result of the audit; and
provide the result of the audit for display.

19. The system of claim 18 wherein the audit is of revenue, and the executable instructions are further executable by the at least one processor to:
receive an amount of the revenue;
determine, based on the one or more second particular final output audit data, an audited amount of the revenue; and
determine, based on the amount of the revenue and the audited amount of the revenue, the result of the audit.

20. The system of claim 15 wherein the audit is a first audit, the particular input configuration is a first particular input configuration, the particular initial input audit data is first particular initial input audit data, the particular output configuration is a first particular output configuration, and the executable instructions are further executable by the at least one processor to:
receive a request to create a second audit, the request specifying the party;
receive a request to associate the particular process with the second audit;
receive a second particular input configuration specifying second particular initial input audit data for the particular input block;
receive a second particular output configuration for the particular output block;
receive a request to execute the particular process for the second audit;
receive the second particular initial input audit data specified by the second particular input configuration;
apply the one or more modifications specified by the one or more particular modification configurations of the one or more particular modification blocks to the second particular initial input audit data to produce second particular final output audit data;
store the second particular final output audit data according to the second particular output configuration; and
provide the second particular final output audit data for display.
